(19) United States
(12) Patent Application Publication
(10) Pub. No.: US 2026/0027008 A1
(43) Pub. Date: Jan. 29, 2026

(54) MATERIALS AND METHODS FOR MITIGATING THE PRESENCE OF NITROSAMINES IN PACKAGING USING ACTIVATED CARBON OR A DERIVATIVE THEREOF

(71) Applicant: CSP TECHNOLOGIES, INC., AUBURN, AL (US)

(72) Inventors: MADISON PIPKIN, AUBURN, AL (US); JASON PRATT, AUBURN, AL (US); MATTHEW RICCIO, AUBURN, AL (US); SHARMILA KURAPATI, AUBURN, AL (US); JAMES S. HOLLINGER, AUBURN, AL (US); JONATHAN R. FREEDMAN, ATLANTA, GA (US); WILLIAM FREDERICK SPANO, AUBURN, AL (US); JOHN BELFANCE, AUBURN, AL (US); FRANKLIN LEE LUCAS, JR., OPELIKA, AL (US); IVY COMER, AUBURN, AL (US); AMANDA MURPH, AUBURN, AL (US); WILLIAM TYROLT, AUBURN, AL (US); JEAN DAOU, MULHOUSE (FR)

(21) Appl. No.: 19/345,725

(22) Filed: Sep. 30, 2025

Related U.S. Application Data
(63) Continuation of application No. PCT/US2024/022539, filed on Apr. 1, 2024.
(60) Provisional application No. 63/493,622, filed on Mar. 31, 2023.
(60) Provisional application No. 63/493,654, filed on Mar. 31, 2023.
(60) Provisional application No. 63/580,592, filed on Sep. 5, 2023.

(51) Int. Cl. A61J 1/03; B65D 75/36; B65D 75/52

(52) U.S. Cl. CPC A61J 1/035; B65D 75/36; B65D 75/52; B65D 2201/00; B65D 2581/00; B65D 2585/56

(57) ABSTRACT

Disclosed herein are materials, articles of manufacture, and methods for reducing, mitigating, or precluding formation of and/or amount of a nitrosating agent and/or an N-nitroso compound, including an N-nitrosamine, from a packaging containing an active agent and a pharmaceutical dosage form in an enclosure, wherein the active agent is effective to reduce mitigate or preclude the formation and/or amount of a nitrosating agent and/or N-nitroso compound in the enclosure and/or in the pharmaceutical dosage form. Provided are drug delivery systems comprising a blister pack configured to house multiple pharmaceutical dosage forms, the blister pack comprising an active ingredient that is effective to reduce, mitigate or preclude the formation and/or amount of a nitrosating agent and/or N-nitroso compound in an enclosure of the blister pack and/or in the pharmaceutical dosage form.

### CROSS-REFERENCE TO RELATED APPLICATIONS

The present application claims priority to U.S. Provisional Application No. 63/493,622, titled “MATERIALS AND METHODS FOR SCAVENGING OF N-NITROSO COMPOUNDS IN PACKAGING” and filed on Mar. 31, 2023, U.S. Provisional Application No. 63/493,654, titled “MATERIALS AND METHODS FOR SCAVENGING OF N-NITROSAMINES IN PACKAGING” and filed on Mar. 31, 2023, and U.S. Provisional Application No. 63/580,592, titled “BLOWN FILMS WITH VOLATILE ORGANIC COMPOUND SCAVENGING AGENT AND METHODS OF MAKING THE SAME” and filed Sep. 5, 2023. Each of the aforementioned priority applications is hereby incorporated by reference in its entirety.

### FIELD OF THE INVENTION

The disclosed concept includes materials, articles of manufacture, and methods for scavenging N-nitroso compounds, such as N-nitrosamines, from packaging that contains a quantity of a product that is susceptible to contamination by a N-nitroso compound, to reduce the amount of, or mitigate (or preclude) the formation of, N-nitroso compounds, such as N-nitrosamines.

### BACKGROUND OF THE INVENTION

The group of compounds termed N-nitroso compounds (NOCs) bears the common >N—N═O moiety. This group can be further divided into two subgroups: (i) N-nitrosamines and (ii) N-nitrosamides and related compounds. N-Nitrosamines are N-nitroso derivatives of secondary amines; N-nitrosamides and their related compounds are those of substituted ureas, amides, carbamates, guanidines, and similar compounds.

The group is of interest due to evidence of the mutagenic and carcinogenic properties of its members. Most NOCs induce cancer in laboratory animals and may be involved in the etiology of several human cancers. The wide range of human exposure sources (exogenous and endogenous) have led to regulatory and legislative action and the development of advanced and sensitive methods of analysis.

Reaction of primary and secondary amines with nitrites or nitrous acid can lead to the production of NOCs, in which an N—H moiety is replaced with an N—N═O moiety.

Pharmaceuticals and foodstuffs containing primary and secondary amines are therefore susceptible to N-nitrosamine contamination due to the reaction, over time, with nitrites or nitrous acid. Thus, strategies to reduce the rate of formation of NOCs, or preclude their formation, can reduce or minimize the health risk from consumption of these products. In turn, materials and methods for reducing or eliminating the amount of N-nitrosamines and/or nitrosating agent, e.g., nitrites and/or nitrous acid, from packaging for these goods, as well as reducing or eliminating the amount of N-nitrosamines present in the good itself, can serve to minimize the health risk due to exposure to NOC contaminants in these products.

Pharmaceutical compositions are expected to be safe and, in general, in compliance with requirements of governmental regulatory rules, such as the United States FDA regulations. In addition, the level of impurities present in the pharmaceutical composition should comply with requirements outlined in by the U.S. FDA. The FDA has been investigating the presence of nitrosamine impurities in some types of medications. The FDA has set acceptable daily intake limits for nitrosamines. See “Recommended Acceptable Intake Limits for Nitrosamine Drug Substance-Related Impurities”, U.S. Department of Health and Human Services Food and Drug Administration, Center for Drug Evaluation and Research, Pharmacology/Toxicology, Aug. 4, 2023. The FDA has identified acceptable intake (AI) limits as follows:

| Nitrosamines | AI Limit (ng/day) |
|---|---|
| NDMA | 96 |
| NDEA | 26.5 |
| NMBA | 96 |
| NMPA | 26.5 |
| NIPEA | 26.5 |
| NDIPA | 26.5 |

The AI limit is a daily exposure to a compound such as those above that approximates a 1:100,000 cancer risk after 70 years of exposure. See “Control of Nitrosamine Impurities in Human Drugs/Guidance for Industry”, Pharmaceutical Quality/Manufacturing Standards/Current Good Manufacturing Practice/Rev. 1, February 2021.

There are multiple reasons why nitrosamines can be present in drugs. It has been found that the source of nitrosamines can be related to the drug's manufacturing process or its chemical structure or even the conditions in which they are stored or packaged. Nitrosamine impurities may increase the risk of cancer if people are exposed to them above an acceptable level and over long periods of time.

Several NOCs are significant environmental and workplace pollutants, and can be found in smoke, including the smoke from combustion of tobacco.

It is necessary to reduce the amount of nitrosamines in pharmaceutical and medicament compositions and their packaging to meet safety standards and reduce the risk of nitrosamine exposure to patients taking the drugs. Thus, there remains a need for materials, articles of manufacture, and methods that can scavenge N-nitroso compounds and/or nitrosating agent, e.g., nitrites and/or nitrous acid from packaging and/or the goods enclosed therein, wherein the goods comprise a quantity of a product, e.g., pharmaceutical or foodstuff, that is susceptible to contamination by N-nitroso compounds, to reduce the amount of N-nitroso compounds in the goods and/or the packaging, or mitigate (or preclude) the formation of N-nitroso compounds in the goods and/or the packaging. There is also a need for a solution that does not require reformulating a pharmaceutical composition (e.g., by putting a mitigant in the composition itself) or changing the process by which the pharmaceutical composition is manufactured. The desired materials, articles of manufacture and methods would reduce the levels of free N-nitroso compounds in products (e.g., pharmaceutical compositions), thereby reducing the hazards associated with these compounds.

### SUMMARY OF THE INVENTION

Provided herein is a container comprising a scavenging material that is capable of removing a nitrosating agent and/or an N-nitroso compound from a headspace within the container.

Also provided herein is a method for the manufacture of a container comprising a scavenging material that is capable of removing a nitrosating agent and/or an N-nitroso compound from a headspace within the container.

Provided is a method for treating a patient having a medical condition with a pharmaceutical dosage form that comprises or can form a nitrosating agent and/or a N-nitroso compound, the method being configured to mitigate a potential adverse effect on a patient associated with the nitrosating agent and/or N-nitroso compound, the method comprising:
(a) providing a package comprising an enclosure and one or more pharmaceutical dosage forms housed within the enclosure, wherein a headspace is formed within a volume of the enclosure that is not occupied by the one or more pharmaceutical dosage forms;
(b) providing an amount of activated carbon and/or a derivative thereof in the headspace that is effective in reducing the rate of formation or inhibiting formation of a nitrosating agent and/or an N-nitroso compound in a headspace and/or in the pharmaceutical dosage form within the package, the amount of activated carbon and/or derivative thereof being separate and apart from the one or more pharmaceutical dosage forms;
(c) opening the enclosure to dispense the one or more pharmaceutical dosage forms; and
(d) administering the one or more pharmaceutical dosage forms to provide a therapeutically effective amount of drug to the patient for treating the medical condition with improved patient safety by reducing the potential adverse effect associated with the pharmaceutical dosage form through mitigation of the nitrosating agent and/or N-nitroso compound by the amount of activated carbon or derivative thereof.

Provided is a method of reducing, mitigating or precluding formation of and/or amount of nitrosating agent and/or an N-nitroso compound in a pharmaceutical drug package, comprising:
providing an enclosure;
positioning at least one pharmaceutical dosage form in the enclosure;
forming a headspace in the enclosure not occupied by the at least one pharmaceutical dosage form; and
   positioning activated carbon and/or a derivative thereof within the headspace, wherein the activated carbon and/or a derivative thereof is effective to reduce, mitigate or preclude the formation and/or amount of nitrosating agent and/or N-nitroso compound in the headspace and/or in the pharmaceutical dosage form.

In some embodiments, one or more of the headspace and the at least one pharmaceutical dosage form includes a nitrosating agent and/or an N-nitroso compound.

Also provided is a drug delivery system for mitigating a potential adverse effect associated with the drug, the system comprising:
(a) a blister pack configured to house one or more pharmaceutical dosage forms, the blister pack comprising:
   (i) a backing;
   (ii) a cover attached to the backing, the cover and backing in combination forming at least one enclosure configured to contain a single pharmaceutical dosage form;
(b) a single pharmaceutical dosage form housed within at least one enclosure;
(c) a headspace formed within a volume of the enclosure that is not occupied by the one or more pharmaceutical dosage forms; and
d) activated carbon or a derivative thereof dispersed in a base polymer to form an entrained polymer film that is capable of reducing the rate of formation or inhibiting formation of a nitrosating agent and/or an N-nitroso compound in a headspace within the package and/or in the pharmaceutical dosage form,
   wherein the entrained polymer film is separate and apart from the single pharmaceutical dosage form.

### BRIEF DESCRIPTION OF THE DRAWINGS

The foregoing summary, as well as the following detailed description of the presently disclosed technology, will be better understood when read in conjunction with the appended drawings, wherein like numerals designate like elements throughout. For the purpose of illustrating the presently disclosed technology, there are shown in the drawings various illustrative embodiments. It should be understood, however, that the presently disclosed technology is not limited to the precise arrangements and instrumentalities shown. In the drawings:

FIG. 1 is a schematic illustration of a representative apparatus and process for forming blown film according to an optional embodiment of the disclosed concept; and

FIG. 2 is a schematic illustration of a blister pack for storing a medicament according to an optional embodiment of the disclosed concept.

### DETAILED DESCRIPTION OF PREFERRED EMBODIMENTS

While systems, devices and methods are described herein by way of examples and embodiments, those skilled in the art recognize that the systems, devices and methods of the presently disclosed technology are not limited to the embodiments or drawings described. Rather, the presently disclosed technology covers all modifications, equivalents and alternatives falling within the spirit and scope of the appended claims. Any headings used herein are for organizational purposes only and are not meant to limit the scope of the description or the claims.

Accordingly, provided herein is a container comprising a scavenging material that is capable of removing an N-nitroso compound and/or a nitrosating agent, e.g. nitrite and/or nitrous acid, from a headspace within the container and/or from goods enclosed in the container. Also provided herein is a method for scavenging an N-nitroso compound and/or nitrosating agent, e.g. nitrite and/or nitrous acid, in order to reduce the rate of, or inhibit the formation of, or remove an N-nitroso compound and/or nitrosating agent, e.g. nitrite or nitrous acid, from the container and/or the goods enclosed therein. Optionally, the scavenging material reduces the amount of an N-nitroso compound. Optionally, the scavenging material reduces the amount of nitrite and/or nitrous acid.

Optionally, the disclosed concept includes a system for mitigating the presence of nitrosamine impurities from a drug product and a potential adverse effect on a patient that uses the drug product. The system includes a package that includes an enclosure and one or more pharmaceutical dosage forms having in it, on it, or having a propensity to form or emit, an N-nitroso compound and/or a nitrosating agent, e.g., nitrite or nitrous acid. A headspace is formed within a volume of the enclosure that is not occupied by the one or more pharmaceutical dosage forms. Disposed within the headspace is an effective amount of an active agent to inhibit formation of and/or reduce the presence of the N-nitroso compound and/or nitrosating agent in or on the one or more pharmaceutical dosage forms and/or in the headspace.

Optionally, the disclosed concept includes a method of reducing, mitigating or precluding formation of and/or controlling the amount of an N-nitroso compound and/or a nitrosating agent in a pharmaceutical drug package. The method includes forming a headspace in the enclosure not occupied by a pharmaceutical dosage form and positioning an active agent within the enclosure. Optionally, one or both of the headspace and the pharmaceutical dosage form includes an N-nitroso compound and/or a nitrosating agent. The active agent is effective to reduce, mitigate or preclude the formation and/or amount of the N-nitroso compound and/or the nitrosating agent in the headspace and/or in the pharmaceutical dosage form.

Optionally, the active agent is effective to reduce, mitigate or preclude the formation and/or amount of the N-nitroso compound in the headspace to less than 1500 ppm, optionally less than 400 ppm, optionally less than 100 ppm, optionally less than 95 ppm, optionally less than 90 ppm, optionally less than 85 ppm, optionally less than 80 ppm, optionally less than 75 ppm, optionally less than 70 ppm, optionally less than 65 ppm, optionally less than 60 ppm, optionally less than 55 ppm, optionally less than 50 ppm, optionally less than 45 ppm, optionally less than 40 ppm, optionally less than 35 ppm, optionally less than 25 ppm, optionally less than 20 ppm, optionally less than 15 ppm, optionally less than 14 ppm, optionally less than 13 ppm, optionally less than 12 ppm, optionally less than 11 ppm, optionally less than 10 ppm, optionally less than 9 ppm, optionally less than 8 ppm, optionally less than 7 ppm, optionally less than 6 ppm, optionally less than 5 ppm, optionally less than 4 ppm, optionally less than 3 ppm, optionally less than 2 ppm, optionally less than 1 ppm, optionally less than 0.9 ppm, optionally less than 0.8 ppm, optionally less than 0.7 ppm, optionally less than 0.6 ppm, optionally less than 0.5 ppm, optionally less than 0.4 ppm, optionally less than 0.3 ppm, optionally less than 0.2 ppm, or optionally less than 0.1 ppm.

Optionally, the active agent is effective to reduce, mitigate or preclude the formation and/or amount of the N-nitroso compound in the pharmaceutical dosage form to less than 1500 ppm, optionally less than 400 ppm, optionally less than 100 ppm, optionally less than 95 ppm, optionally less than 90 ppm, optionally less than 85 ppm, optionally less than 80 ppm, optionally less than 75 ppm, optionally less than 70 ppm, optionally less than 65 ppm, optionally less than 60 ppm, optionally less than 55 ppm, optionally less than 50 ppm, optionally less than 45 ppm, optionally less than 40 ppm, optionally less than 35 ppm, optionally less than 25 ppm, optionally less than 20 ppm, optionally less than 15 ppm, optionally less than 14 ppm, optionally less than 13 ppm, optionally less than 12 ppm, optionally less than 11 ppm, optionally less than 10 ppm, optionally less than 9 ppm, optionally less than 8 ppm, optionally less than 7 ppm, optionally less than 6 ppm, optionally less than 5 ppm, optionally less than 4 ppm, optionally less than 3 ppm, optionally less than 2 ppm, optionally less than 1 ppm, optionally less than 0.9 ppm, optionally less than 0.8 ppm, optionally less than 0.7 ppm, optionally less than 0.6 ppm, optionally less than 0.5 ppm, optionally less than 0.4 ppm, optionally less than 0.3 ppm, optionally less than 0.2 ppm, or optionally less than 0.1 ppm.

Optionally, the active agent is effective to reduce, mitigate or preclude the formation and/or amount of the nitrosating agent in the headspace to less than 1500 ppm, optionally less than 400 ppm, optionally less than 100 ppm, optionally less than 95 ppm, optionally less than 90 ppm, optionally less than 85 ppm, optionally less than 80 ppm, optionally less than 75 ppm, optionally less than 70 ppm, optionally less than 65 ppm, optionally less than 60 ppm, optionally less than 55 ppm, optionally less than 50 ppm, optionally less than 45 ppm, optionally less than 40 ppm, optionally less than 35 ppm, optionally less than 25 ppm, optionally less than 20 ppm, optionally less than 15 ppm, optionally less than 14 ppm, optionally less than 13 ppm, optionally less than 12 ppm, optionally less than 11 ppm, optionally less than 10 ppm, optionally less than 9 ppm, optionally less than 8 ppm, optionally less than 7 ppm, optionally less than 6 ppm, optionally less than 5 ppm, optionally less than 4 ppm, optionally less than 3 ppm, optionally less than 2 ppm, optionally less than 1 ppm, optionally less than 0.9 ppm, optionally less than 0.8 ppm, optionally less than 0.7 ppm, optionally less than 0.6 ppm, optionally less than 0.5 ppm, optionally less than 0.4 ppm, optionally less than 0.3 ppm, optionally less than 0.2 ppm, or optionally less than 0.1 ppm.

Optionally, the active agent is effective to reduce, mitigate or preclude the formation and/or amount of the nitrosating agent in the pharmaceutical dosage form to less than 1500 ppm, optionally less than 400 ppm, optionally less than 100 ppm, optionally less than 95 ppm, optionally less than 90 ppm, optionally less than 85 ppm, optionally less than 80 ppm, optionally less than 75 ppm, optionally less than 70 ppm, optionally less than 65 ppm, optionally less than 60 ppm, optionally less than 55 ppm, optionally less than 50 ppm, optionally less than 45 ppm, optionally less than 40 ppm, optionally less than 35 ppm, optionally less than 25 ppm, optionally less than 20 ppm, optionally less than 15 ppm, optionally less than 14 ppm, optionally less than 13 ppm, optionally less than 12 ppm, optionally less than 11 ppm, optionally less than 10 ppm, optionally less than 9 ppm, optionally less than 8 ppm, optionally less than 7 ppm, optionally less than 6 ppm, optionally less than 5 ppm, optionally less than 4 ppm, optionally less than 3 ppm, optionally less than 2 ppm, optionally less than 1 ppm, optionally less than 0.9 ppm, optionally less than 0.8 ppm, optionally less than 0.7 ppm, optionally less than 0.6 ppm, optionally less than 0.5 ppm, optionally less than 0.4 ppm, optionally less than 0.3 ppm, optionally less than 0.2 ppm, or optionally less than 0.1 ppm.

Optionally, the active agent comprises a scavenging material. Optionally, the scavenging material comprises a microporous material. Optionally, the microporous material is carbon. Optionally, the microporous material is activated carbon or a derivative thereof. Optionally, the activated carbon or a derivative thereof is in the form of powder, granules, or beads.

Optionally, the scavenging material comprises a base. Optionally, the base is an organic amine. Optionally, the organic amine comprises at least one hydroxyl group. Optionally, the organic amine contains at most 8 carbons, optionally at most 6 carbons, optionally at most 4 carbons. Optionally, the organic amine contains at most 3 nitrogens, optionally at most 2 nitrogens, optionally 1 nitrogen. Optionally, the organic amine contains 3 oxygens or fewer, optionally 2 oxygens or fewer, optionally at most 1 oxygen. Optionally, all of the nitrogens in the organic amine are amino nitrogens. Optionally, all of the oxygens in the organic amine are hydroxyl nitrogens. Optionally, the pKa for the conjugate acid of the organic amine is between 6 and 11, optionally between 6 and 10, optionally between 6.5 and 10, optionally between 6.5 and 9.5, optionally between 6.5 and 9, optionally between 6.5 and 8.5. Optionally, the organic amine is chosen from ethanolamine, diethanolamine, triethanolamine, and tris(hydroxymethyl)aminomethane. Optionally, the organic base is a monoacidic base. Optionally, the scavenging material further comprises the conjugate acid of the monoacidic base. Optionally, the monoacidic base and the conjugate acid of the monoacidic base are provided in a ratio between 30:70 and 70:30, optionally between 35:65 and 65:35, optionally between 40:60 and 60:40, optionally between 45:55 and 55:45.

Optionally, the activated carbon is modified with an amine base to create a derivative of the activated carbon. Optionally, the amine base is tris(hydroxymethyl) amino methane (“tris-activated carbon”).

Optionally, the activated carbon is modified with the amine base via the steps of: partially oxidizing the activated carbon to provide carboxylic acid moieties; and coupling the amine base with carboxylic acid moieties to form amides.

Also provided herein is a method for the manufacture of a container comprising a scavenging material that is capable of removing an N-nitroso compound, nitrite or nitrous acid from a headspace within the container.

The disclosed concept also includes a drug delivery system that includes a blister pack configured to house multiple pharmaceutical dosage forms. The blister pack includes a backing and a cover attached to the backing. In combination, the cover and backing form at least one enclosure. A single pharmaceutical dosage form is housed within at least one of the enclosures, and a headspace is formed within a volume of the at least one enclosure that is not occupied by the pharmaceutical dosage form. Additionally, an active agent is positioned in at least one of the enclosures. The active agent is effective for reducing or controlling the formation and/or concentration of an N-nitroso compound and/or nitrosating agent, e.g., nitrite and/or nitrous acid, in the headspace and/or in the pharmaceutical dosage form.

Optionally, the product susceptible to contamination by an N-nitroso compound is a foodstuff. Optionally, the product susceptible to contamination by an N-nitroso compound is a medicament.

Optionally, the period of storage is no less than 1 week, optionally no less than 2 weeks, optionally no less than 3 weeks, optionally no less than 6 weeks, optionally no less than 13 weeks, optionally no less than 26 weeks, optionally no less than 1 year, optionally from 26 weeks to 3 years, optionally from 1 year to 3 years, optionally from 1 year to 2 years, optionally from 2 years to 3 years, optionally about 2 years.

Optionally, the period of storage is no more than 1 year, optionally no more than 26 weeks, optionally no more than 13 weeks, optionally no more than 6 weeks, optionally no more than 3 weeks, optionally no more than 2 weeks, optionally no more than 1 week, optionally from 1 week to 1 year, optionally from 13 weeks to 1 year.

Optionally, the product itself contains an N-nitroso compound and/or nitrosating agent, e.g., nitrite or nitrous acid, prior to packaging, i.e., formed during synthesis or formulation prior to placement or storage in a container or package. Optionally, the product emits a nitrosating agent, e.g. nitrite or a nitrous acid, in the package, i.e., when stored in the container or package, that reacts with a primary or secondary amine to form an N-nitroso compound in the product and/or in the headspace of the container or package in the absence of any preventative measures.

Optionally, the initial rate for uptake of the N-nitroso compound and/or nitrosating agent, e.g., nitrite or nitrous acid, by the scavenging material is less than the rate of formation of the N-nitroso compound and/or nitrosating agent, e.g., nitrite or nitrous acid, in the container or package. Optionally, the initial rate for uptake of the N-nitroso compound and/or nitrosating agent, e.g., nitrite or nitrous acid, by the scavenging material is greater than the rate of formation of the N-nitroso compound and/or nitrosating agent, e.g., nitrite or nitrous acid, in the container or package. Optionally, essentially no N-nitroso compound and/or nitrosating agent, e.g., nitrite or nitrous acid, is formed during the period of storage.

The disclosed concept also includes a method for treating a patient having a medical condition with a pharmaceutical dosage form that includes or forms an N-nitroso compound and/or a nitrosating agent. The method is configured to mitigate a potential adverse effect on a patient associated with the N-nitroso compound and/or the nitrosating agent. The method includes providing a package comprising an enclosure and one or more pharmaceutical dosage forms housed within the enclosure, with a headspace being formed within a volume of the enclosure that is not occupied by the one or more pharmaceutical dosage forms. The method further includes providing an amount of an active agent, e.g., a scavenging material, in the headspace, that is effective in scavenging an N-nitroso compound and/or nitrosating agent or in reducing the rate of formation or inhibiting formation of an N-nitroso compound and/or nitrosating agent, e.g., nitrite or nitrous acid, in a headspace and/or in the pharmaceutical dosage form within the container. The amount of active agent is separate and apart from the one or more pharmaceutical dosage forms. The one or more pharmaceutical dosage forms is removed from the enclosure for administering a therapeutically effective amount of drug to the patient for treating the medical condition with improved patient safety by reducing the potential adverse effect associated with the pharmaceutical dosage form through mitigation of the N-nitroso compound and/or nitrosating agent by the amount of the active agent.

Optionally, the N-nitroso compound has a formula weight of 300 g/mol or less, optionally 200 g/mol or less, optionally 160 g/mol or less, optionally 120 g/mol or less.

Optionally, the N-nitroso compound has a vapor pressure at 20° C. of 0.2 Torr or higher, optionally 0.5 Torr or higher, optionally 1 Torr or higher, optionally 2 Torr or higher, optionally 3 torr or higher, optionally 4 torr or higher, or optionally 5 Torr or higher.

Optionally, the N-nitroso compound has a boiling point at atmospheric pressure of 250° C. or lower, optionally 225° C. or lower, optionally 200° C. or lower, optionally 190° C. or lower, optionally 180° C. or lower, optionally 170° C. or lower, or optionally 160° C. or lower.

Optionally, the N-nitroso compound is the N-nitroso derivative of a aliphatic secondary amine. Optionally, the aliphatic secondary amine is a cyclic amine. Optionally, the aliphatic secondary amine is an acyclic amine.

Optionally, the aliphatic secondary amine is composed of elements chosen from C, H, N, and O.

Optionally, the aliphatic secondary amine is composed of elements chosen from C, H and N.

Optionally, the aliphatic secondary amine has 10 carbons or fewer, optionally 8 carbons or fewer, optionally 6 carbons or fewer, optionally 4 carbons or fewer. Optionally, the aliphatic secondary amine has 1, 2, or 3 nitrogens, optionally 1 or 2 nitrogens, optionally 1 nitrogen. Optionally, the aliphatic secondary amine has zero, 1, or 2 oxygens, optionally zero or 1 oxygens, optionally zero oxygens.

Optionally, the N-nitroso compound has the formula R¹R²N—N═O, wherein R¹ and R² are independently chosen from C₁₋₆alkyl, C₃₋₇cycloalkyl, and 4- to 7-membered heterocycloalkyl.

Optionally, the N-nitroso compound has the formula R¹R²N—N═O, wherein R¹ and R² combine to form a 4- to 7-membered heterocycloalkyl optionally substituted with an R³ chosen from C₁₋₆alkyl and C₃₋₇cycloalkyl. Optionally, the 4- to 7-membered heterocycloalkyl is chosen from pyrrolidine, piperidine, and piperazine.

Optionally, the N-nitroso compound is chosen from N-nitrosodimethylamine (NDMA), N-nitrosodiethylamine (NDEA), N-nitrosodi-1-propylamine (NDPA), N-nitrosodi-2-propylamine (NDIPA), N-nitrosodi-1-butylamine (NDBA), N-nitroso-N-ethyl-2-propylamine (NEIPA), N-nitroso-N′-methylpiperazine (NMP), N-nitroso-N′-cyclopentylpiperazine (CPNP), and N-nitrosopyrrolidine (NPYR). Optionally, the N-nitroso compound is N-nitrosodimethylamine. Optionally, the N-nitroso compound is neither of 1-methyl-4-nitrosopiperazine, 1-cyclopentyl-4-nitrosopiperazine, or N-nitroso-3-azabicyclo[3.3.0]octane.

Optionally, the pharmaceutical dosage form that is mitigated through the methods, materials and systems disclosed herein may include one or more of the following or a pharmaceutically acceptable salt thereof: Metformin, Ranitidine, Amitriptyline, Nortriptyline, Betahistine, Chloropyramine, Citalopram, Sumatriptan, Lamisil, Terbisil, Zostavax, Tripelennamine, Desvenlafaxine, Orphenadrine, Terbinafine, Ethylisopropylamine, Sitagliptin, Losartan, Valsartan, Atomoxetine, Lidocaine, Azelastine, Duloxetine, Fluoxetine, Chloropyramine, Phenylephrine, Rasagiline, Reboxetine, Aripiprazole, Mitapivat, Rifampicin, Alogliptin, Ranolazine, Rotigotine, Azacyclonol, Quetiapine, Cinacalcet, Desloratadine, Nintedanib, Sildenafil, Landiolol, Mirabegron, Mirtazapine, Valaciclovir, Pramipexole, Ranolazine, Ribociclib, Tetracaine, Trimetazidine, Varenicline, Vortioxetine, Methylphenidate, Paroxetine, Piperidine, Moxifloxacin, Daridorexant, Rotigotine, Ropivacaine, Ambroxol, Atenolol, Benazepril, Betaxolol, Bisoprolol, Bumetanide, Bupropion, Celiprolol, Cilazapril, Ciprofloxacin, Dabigatran Etexilate, Trimebutine, Diclofenac, Dorzolamide, Enalapril, Esmolol, Isosorbide mononitrate, Imatinib, Isosorbide mononitrate, Indapamide, Ketamine, Labetalol, Leniolisib, Levofloxacin, Lisinopril, Metoprolol, Moxifloxacin, Nebivolol, Perindopril, Arpraziquantel, Propranolol, Pseudoephedrine, Quetiapine, Ramipril, Rivaroxaban, Salbutamol, Sertraline, Sotalol, Tamsulosin, Ticagrelor, Urapidil, Vildagliptin, Gliclazide, Mefenamic acid, Azithromycin, Calcium folinate, Calcium levofolinate, Azithromycin, Hydrochlorothiazide and Quinapril.

Optionally, the pharmaceutical dosage form that is mitigated through the methods, materials and systems disclosed herein does not comprise any one of rifampicin, rifapentine, or gliclazide. Optionally, the pharmaceutical dosage form that is mitigated through the methods, materials and systems disclosed herein does not comprise a compound with either a hydrazone or a semicarbazide moiety. Optionally, the pharmaceutical dosage form that is mitigated through the methods, materials and systems disclosed herein does not comprise a compound that can undergo hydrolysis to provide a primary hydrazine.

It will be understood that the materials and methods disclosed herein may be of general applicability to NOCs, including both N-nitrosamines and N-nitrosamides.

Without intending to be bound by a particular theory, it is thought that certain amines, particuarly secondary amines R¹R²NH, are susceptible to nitrosation by nitrous acid, nitrites and other nitrosating agents to form N-nitrosamines, which are generally genotoxic and/or carcinogenic. Nitrosation can generally take place at any time during synthesis, formulation, or storage of the medicament.

In certain embodiments, nitrosamines having the formula R¹R²N—NO are produced during decomposition of the product or medicament, with R¹ and R² independently chosen from alkyl, or R^{1,} R², and the intervening nitrogen combine to form an optionally substituted heterocycloalkyl. Optionally, the nitrosamine R¹R²N—NO is formed from secondary amine R¹R²NH, present either in the product or medicament, as a contaminant in the product or medicament formed during synthesis or formulation, or as a decomposition product, reacting with nitrous acid and/or nitrite.

Without limitation, compounds having partial chemical structure R¹R²N—C(═X¹)—X²—, with X¹ and X² independently chosen from NH, O, and S, may undergo fragmentation to provide secondary amine R¹R²NH.

Without limitation, compounds having a partial chemical structure R¹R²N—N═C— may undergo fragmentation to provide secondary amine R¹R²NH.

Without limitation, compounds having a partial chemical structure R¹R²N—C(═NH)—NH—C(═NH)— may undergo fragmentation to provide secondary amine R¹R²NH.

Optionally, a compound or medicament having a partial chemical structure R¹R²N— can undergo a two-step process of nitrosation and fragmentation to produce nitrosamine R¹R²N—NO. Optionally, compounds having partial chemical structure R¹R²N—CH₂—Ar, with Ar being an optionally substituted aryl or heteroaryl moiety, can undergo the two-step nitrosation/fragmentation process to produce nitrosamine R¹R²N—NO.

Optionally, an excipient used in the formulation of a compound or medicament may comprise nitrous acid and/or nitrite capable of reacting with a secondary or teriary amine in the compound or medicament to produce nitrosamine R¹R²N—NO. Optionally, the excipient is microcrystalline cellulose (MCC), colloidal silicon dioxide, hypromellose (HPMC), povidone, mannitol, talc, sodium lauryl sulfate, polyvinyl alcohol, sodium starch glycolate, hydroxypropyl cellulose, poloxamer, citric acid, sodium chloride, sucrose, magnesium stearate, lactose monohydrate, corn starch, starch, croscarmellose sodium, polyethylene glycol, or crospovidone.

In certain embodiments, nitrosamine impurities, such as N-nitrosodimethyl amine (NDMA), N-nitrosodiethyl amine (NDEA), and N-nitrosodiisopropyl amine (NDIPA), result from nitrosable compounds, such as primary, secondary amines, e.g., diethylamine, or tertiary amines, or quaternary ammonium salts, reacting with nitrosating agents, such as nitrous acid, that are formed in-situ from nitrites, such as sodium nitrite.

Optionally, the scavenging material binds to a portion of the N-nitroso compound, thereby removing the portion of the N-nitroso compound from the gas phase. Optionally, the scavenging material binds in a substantially reversible manner. Optionally, the scavenging material binds in a substantially irreversible manner. Optionally, the process of binding of the scavenging material to the N-nitroso compound involves formation of a covalent bond. Optionally, the scavenging material binds to the N-nitroso compound in a noncovalent manner.

Optionally, a portion of the N-nitroso compound undergoes a chemical reaction in the presence of the scavenging material, thereby removing the portion of the N-nitroso compound from the gas phase. Optionally, the chemical reaction is an oxidation. Optionally, the chemical reaction is a reduction. Optionally, the chemical reaction is an addition. Optionally, the chemical reaction is a cycloaddition. Optionally, the chemical reaction is mediated by a radical process.

Optionally, the scavenging material comprises an acid. Optionally, the acid increases the binding affinity of the scavenging material for the N-nitroso compound. Optionally, the acid promotes a chemical reaction of a portion of the N-nitroso compound.

Optionally, the product or medicament contains an N-nitroso compound prior to packaging. Optionally, the container provides sufficient scavenging ability to decrease the amount of N-nitroso compound to below a hazardous level, during a storage period, subsequent to packaging, of 52 weeks, optionally 26 weeks, optionally 13 weeks, optionally 8 weeks, optionally 4 weeks, optionally 2 weeks, optionally 1 week.

Optionally, the product or medicament contains an N-nitroso compound prior to packaging. Optionally, the N-nitroso compound is formed during storage of the product or medicament in the absence of any preventative measures. Optionally, the container provides sufficient scavenging ability to prevent accumulation of N-nitroso compound, to a hazardous level, during a storage period, subsequent to packaging, of 1 week, optionally 2 weeks, optionally 4 weeks, optionally 6 weeks, optionally 13 weeks, optionally 26 weeks, optionally 52 weeks.

Optionally, the product or medicament is stored within the container at substantially ambient temperature.

Optionally, during the period of storage, the container does not exceed a maximum temperature of 50° C. In further embodiments, the maximum temperature is 45° C. or lower, optionally 40° C. or lower, optionally 35° C. or lower, or optionally 30° C. or lower.

Optionally, during the period of storage, the container does not drop below a minimum temperature of −40° C. In further embodiments, the minimum temperature is −35° C. or higher, optionally −30° C. or higher, optionally −25° C. or higher, optionally −20° C. or higher, optionally −15° C. or higher, optionally −10° C. or higher, optionally −5° C. or higher, optionally 0° C. or higher, optionally 5° C. or higher, optionally 10° C. or higher, or optionally 15° C. or higher, optionally 20° C. or higher.

In certain embodiments, the scavenging material is provided in at least one entrained polymer. In certain embodiments, the scavenging material satisfies the requirements for “active agent” defined herein.

In certain embodiments, the entrained polymer comprises a base polymer and optionally a channeling agent.

In certain embodiments, the base polymer ranges from 10% to 70%, optionally from 20% to 60%, optionally from 20% to 50%, optionally from 20% to 40%, optionally from 30% to 70%, optionally from 30% to 60%, from 30% to 50%, optionally from 40% to 70%, optionally from 40% to 60%, optionally from 40% to 50% by weight of the total composition.

In certain embodiments, the channeling agent is in a range from 1% to 20%, optionally 1% to 15%, optionally 1% to 10%, optionally 1% to 5%, optionally from 5% to 20%, optionally 5% to 15%, optionally 5% to 10%, optionally from 10% to 20%, optionally from 10% to 15% by weight with respect to the total weight of the entrained polymer.

Optionally, the container further comprises a desiccant. Optionally, the desiccant comprises silica or silica gel.

Optionally, the container blocks light and/or UV radiation.

Certain embodiments disclosed herein provide methods to obtain a pharmaceutically active composition in a form that is substantially free of an N-nitroso compound, including but not limited to nitrosamine. In some embodiments, the composition contains less than 1500 ppm, optionally less than 400 ppm, optionally less than 100 ppm, optionally less than 95 ppm, optionally less than 90 ppm, optionally less than 85 ppm, optionally less than 80 ppm, optionally less than 75 ppm, optionally less than 70 ppm, optionally less than 65 ppm, optionally less than 60 ppm, optionally less than 55 ppm, optionally less than 50 ppm, optionally less than 45 ppm, optionally less than 40 ppm, optionally less than 35 ppm, optionally less than 25 ppm, optionally less than 20 ppm, optionally less than 15 ppm, optionally less than 14 ppm, optionally less than 13 ppm, optionally less than 12 ppm, optionally less than 11 ppm, optionally less than 10 ppm, optionally less than 9 ppm, optionally less than 8 ppm, optionally less than 7 ppm, optionally less than 6 ppm, optionally less than 5 ppm, optionally less than 4 ppm, optionally less than 3 ppm, optionally less than 2 ppm, optionally less than 1 ppm, optionally less than 0.9 ppm, optionally less than 0.8 ppm, optionally less than 0.7 ppm, optionally less than 0.6 ppm, optionally less than 0.5 ppm, optionally less than 0.4 ppm, optionally less than 0.3 ppm, optionally less than 0.2 ppm, optionally less than 0.1 ppm of total N-nitroso compound. In some embodiments, the standard daily dosage for the composition contains less than 400 ng, optionally less than 200 ng, optionally less than 100 ng, optionally less than 50 ng, optionally less than 26.5 ng, optionally less than 25 ng, optionally less than 20 ng, optionally less than 10 ng, optionally less than 5 ng. In some embodiments, the dosage for the composition contains less than 100%, optionally less than 90%, optionally less than 80%, optionally less than 70% of the FDA or EMA permitted content in effect as of 1 Jan. 2024.

Certain embodiments disclosed herein provide methods to reduce the amount of a N-nitroso compound, including but not limited to nitrosamine, in a pharmaceutically active composition. In some embodiments, reduction in the amount of the N-nitroso compound is accomplished by scavenging the N-nitroso compound. In some embodiments, reduction in the amount of the N-nitroso compound is accomplished by reducing the amount of a primary hydrazine in the composition. In some embodiments, reduction in the amount of the N-nitroso compound is accomplished without reducing the amount of a primary hydrazine in the composition. In some embodiments, reduction in the amount of the N-nitroso compound is accomplished by hydrolyzing a hydrazone or semicarbazone in a compound comprising the pharmaceutically active composition. In some embodiments, reduction in the amount of the N-nitroso compound is accomplished without hydrolyzing a hydrazone or semicarbazone in a compound comprising the pharmaceutically active composition.

Also provided are embodiments wherein any embodiment above may be combined with any one or more of these embodiments, provided the combination is not mutually exclusive.

As used herein, two embodiments are “mutually exclusive” when one is defined to be something which is different than the other.

### Definitions

As used herein, the terms below have the meanings indicated.

### List of Abbreviations

au=arbitrary units; GC=gas chromatography; GC-MS (or GC-MSD)=gas chromatography-mass spectrometry; h=hour; NDMA=N-nitrosodimethylamine; NDEA=N-nitrosodiethylamine; NDPA=N-nitrosodi-1-propylamine; NDIPA=N-nitrosodi-2-propylamine; NDBA=N-nitrosodi-1-butylamine; NEIPA=N-nitroso-N-ethyl-2-propylamine; NMP=N-nitroso-N′-methylpiperazine; CPNP=N-nitroso-N′-cyclopentylpiperazine; NPYR=N-nitrosopyrrolidine; TG-DTA=thermogravimetry/differential thermal analysis; TPSR=temperature programmed surface reaction.

As used herein, the term “selected material” is defined as a material that is acted upon, by, or interacts or reacts with an active agent and is capable of being transmitted through the channels of an entrained polymer. The selected material of primary focus in this specification are N-nitrosamines.

As used herein, the term “amine” refers to a compound R¹R²R³N, wherein R¹, R², and R³ are independently chosen from H, alkyl, and aryl, and two of R¹, R², and R³ can combine to form a ring. The term “primary amine” refers to an amine wherein two of R¹, R², and R³ are H. The term “secondary amine” refers to an amine wherein one of R¹, R², and R³ are H. The term “tertiary amine” refers to an amine wherein none of R¹, R², and R³ is H. The term “cyclic amine” refers to an amine wherein two of R¹, R², and R³ combine to form a ring. The term “acyclic amine” refers to an amine wherein no two of of R¹, R², and R³ combine to form a ring. The term “aliphatic amine” refers to an amine wherein R¹, R², and R³ are independently chosen from H and alkyl, and two of R¹, R², and R³ can combine to form a ring. The term “aryl amine” refers to an amine wherein at least one of R¹, R², and R³ is aryl.

As used herein, the term “active agent” is defined as a material that (1) is preferably immiscible with the base polymer and when mixed and heated with the base polymer and the channeling agent, will not melt, i.e., has a melting point that is higher than the melting point for either the base polymer or the channeling agent, and (2) acts on, interacts or reacts with a selected material. The term “active agent” may include but is not limited to materials that absorb, adsorb or release the selected material(s). The “active agent” may include a “scavenging material”. The preferred active agent in the present disclosure is activated carbon or a derivative thereof.

As used herein, the term “base polymer” is a polymer optionally having a gas transmission rate of a selected material that is substantially lower than, lower than or substantially equivalent to, that of the channeling agent. By way of example, such a transmission rate is a vapor transmission rate in embodiments where the selected material is an N-nitroso compound and the active agent is a scavenging material capable of removing an N-nitroso compound from a volume of gas in contact with the entrained polymer. The primary function of the base polymer is to provide structure for the entrained polymer.

Suitable base polymers for use in the disclosure include thermoplastic polymers, e.g., polyolefins such as polypropylene and polyethylene, polyisoprene, polybutadiene, polybutene, polysiloxane, polycarbonates, polyamides, ethylene-vinyl acetate copolymers, ethylene-methacrylate copolymer, poly(vinylchloride), polystyrene, polyesters, polyanhydrides, polyacrylianitrile, polysulfones, polyacrylic ester, acrylic, polyurethane and polyacetal, or copolymers or mixtures thereof.

In certain embodiments, the channeling agent has a vapor transmission rate of at least two times that of the base polymer. In other embodiments, the channeling agent has a vapor transmission rate of at least five times that of the base polymer. In other embodiments, the channeling agent has a vapor transmission rate of at least ten times that of the base polymer. In still other embodiments, the channeling agent has a vapor transmission rate of at least twenty times that of the base polymer. In still another embodiment, the channeling agent has a vapor transmission rate of at least fifty times that of the base polymer. In still other embodiments, the channeling agent has a vapor transmission rate of at least one hundred times that of the base polymer.

As used herein, the term “channeling agent” or “channeling agents” is defined as a material that is immiscible with the base polymer and has an affinity to transport a fluid (liquid or gas phase) substance at a faster rate than the base polymer. Optionally, a channeling agent is capable of forming channels through the entrained polymer when formed by mixing the channeling agent with the base polymer. Optionally, such channels are capable of transmitting a selected material through the entrained polymer at a faster rate than in solely the base polymer.

As used herein, the term “channels” or “interconnecting channels” is defined as passages formed of the channeling agent that penetrate through the base polymer and may be interconnected with each other.

As used herein, the term “entrained polymer” is defined as a monolithic material formed of at least a base polymer, an active agent, and optionally also a channeling agent entrained or distributed throughout. An entrained polymer thus has at least two phases (without a channeling agent) or at least three phases (with a channeling agent).

As used herein, the term “headspace” is defined as the volume within a package that is not occupied by the good or product stored therein. The singular term “headspace” typically, but not necessarily, refers to a contiguous volume. Use of the term “headspace” does not imply a lower limit to volume. Optionally, a headspace can be filled with a gas, or a mixture of gases, whose composition differs from that of atmosphere. Unless otherwise indicated, the gas within the headspace does not undergo appreciable exchange with the exterior atmosphere.

Some packages may provide separate compartments for individual units of the good or product, including but not limited to individual tablets or, alternatively, groups of tablets, each contained within a single compartment, and the headspace of each of which being isolated from other compartments in the package. The package is described as having a plurality of headspaces, one for each of the compartments. The design of such a package allows the retrieval of a single unit of the good or product, while keeping intact the remainder of the compartments in the package.

As used herein, the term “monolithic,” “monolithic structure” or “monolithic composition” is defined as a composition or material that does not consist of two or more discrete macroscopic layers or portions. Accordingly, a “monolithic composition” does not include a multi-layer composite (although a monolithic composition can be a layer of a multi-layer composite).

The term “nitrite” as used herein, alone or in combination, refers to a compound having the general formula R—O—N—O, with R being chosen from H, M⁺, and an organic moiety. The term also includes salts Mₐ(NO₂)_{b} and the anion NO₂⁻. The term therefore includes compounds such as HONO (nitrous acid), NaNO₂ (sodium nitrite), Ca(NO₂)₂ (calcium nitrite), and (CH₃)₂CHCH₂CH₂ONO (isoamyl nitrite).

As used herein, the term “phase” is defined as a portion or component of a monolithic structure or composition that is uniformly distributed throughout, to give the structure or composition its monolithic characteristics.

As used herein, the term “three phase” is defined as a monolithic composition or structure comprising three or more phases. An example of a three phase composition according to the disclosure is an entrained polymer formed of a base polymer, active agent, and channeling agent. Optionally, a three phase composition or structure may include an additional phase, e.g., a colorant, but is nonetheless still considered “three phase” on account of the presence of the three primary functional components.

Furthermore, the terms “package,” “packaging” and “container” may be used interchangeably herein to indicate a vessel having an enclosure that holds or contains a good, e.g., food product or foodstuffs, a pharmaceutical product or a diagnostic test. Optionally, a package may include a container with a product stored therein. Non-limiting examples of a package, packaging and container include a tray, box, carton, bottle receptacle, vessel, pouch and flexible bag. A pouch or flexible bag may be made from, e.g., polypropylene or polyethylene. The package or container may be closed, covered and/or sealed using a variety of mechanisms including a cover, a lid, a cap, lidding sealant, an adhesive and a heat seal, for example. The package or container is composed or constructed of various materials, such as plastic (e.g., polypropylene or polyethylene), paper, Styrofoam, glass, metal and combinations thereof. In one optional embodiment, the package or container is composed of a rigid or semi-rigid polymer, optionally polypropylene or polyethylene, and optionally has sufficient rigidity to retain its shape under gravity.

The term “container” may refer to a single object capable of holding one or more individual goods, including but not limited to pills, tablets, capsules, caplets, liquids, powders, or any other type of individual objects. Optionally, the container has a single interior space. Optionally, the container is partitioned into interior compartments. Optionally, the container partitioned into interior compartments is a blister package. Optionally, the interior compartments allow for vaporous exchange. Optionally, the individual compartments are isolated from each other. Optionally, the individual objects comprise medicaments, nutritional supplements, herbal supplements, or the like. Optionally, the individual objects occupy individual compartments in the container. Optionally, each of the individual objects is packaged in an individual compartment in the container. Optionally, each of the individual compartments is in vaporous communication with at least one other compartment. Optionally, a single contiguous volume is formed by the combination of the individual compartments and passages for vaporous communication among the individual compartments. Optionally, the headspace of each of the individual compartments is isolated from all other compartments.

Optionally, the active pharmaceutical ingredient of a pharmaceutical dosage form that is mitigated through the presently disclosed methods and materials is chosen from an angiotensin-II-receptor antagonist and a histamine H2 receptor antagonist. Optionally, the active pharmaceutical ingredient is chosen from Losartan, Valsartan, Irbesartan, Candesartan, Olmesartan, Eprosartan, Azilsartan, Telmisartan, Ranitidine, Metformin, Nizatidine, Pioglitazone, Rifampin, and Rifapentin.

As used herein, the term “scavenging material” is defined as a material that is capable of removing a compound of interest from a volume of gas. Optionally, the removal is accomplished by a noncovalent binding of the compound of interest to the scavenging material. Optionally, the scavenging material is capable of maintaining a reduced concentration of the compound of interest while the compound of interest is introduced to the volume of gas. In certain embodiments, the scavenging material includes an entrained polymer including the active agent, and the compound of interest is nitrites and/or nitrous acid. The scavenging material includes but is not limited to activated carbon or its derivatives, such as, tris-activated carbon. The scavenging material can be entrained in at least one base polymer with optional channels throughout.

The term “hydrazine” as used herein, alone or in combination, refers a compound comprising the moiety R¹R²—N—NR³R⁴, wherein R¹ and R² are independently chosen from H and substituted or unsubstituted alkyl, cycloalkyl, and aryl. The term “primary hydrazine”, as used herein, alone or in combination, refers to a hydrazine for which at least R¹ and R² are H.

The term “hydrazone” as used herein, alone or in combination, refers to a compound comprising the moiety —C═N—NR¹R², wherein R¹ and R² are independently chosen from H and substituted or unsubstituted alkyl, cycloalkyl, and aryl.

The term “semicarbazone” as used herein, alone or in combination, refers to a compound comprising the moiety —C—O—NH—NR¹R², wherein R¹ and R² are independently chosen from H and substituted or unsubstituted alkyl, cycloalkyl, and aryl.

The term “activated carbon”, as used herein, alone or in combination, refers to a carbonaceous material that has been treated so as to increase surface area and/or porosity. In some embodiments, activated carbon is obtained from coal or charcoal. The term “activated carbon derivative”, as used herein, alone or in combination, refers to activated carbon which has been physically or chemically modified so as to improve the sorption capability of the activated carbon. In some embodiments, the activated carbon is modified by chemical oxidation or auto-oxidation. In some embodiments, oxidation of activated carbon forms carboxyl (—COOH) groups. In some further embodiments, the carboxyl groups thus formed are coupled with primary or secondary amines (NHR¹R²) to introduce amide moieties (—CONR¹R²). In yet further embodiments, the carboxyl groups are coupled with tris(hydroxymethyl)aminomethane, (“Tris”), NH₂—C(CH₂OH)₃ to introduce the following amide moieties: —CONHC(CH₂OH)₃.

In some embodiments, the activated carbon is modified by nitration. In some embodiments, the oxidized activated carbon is further modified by coupling with compounds with ammonia or an amine, thereby providing amides, respectively. In some embodiments, the oxidized activated carbon is further modified by coupling with an alcohol, thereby providing esters. In some embodiments, the activated carbon derivative is obtained by reacting activated carbon with an acid, including but not limited to HNO₃, H₂O₂, HClO, H₂SO₄, and CH₃COOH. In some embodiments, the activated carbon derivative is obtained by reacting activated carbon with a base, including but not limited to NaOH, KOH, and NH₃. In some embodiments, the activated carbon derivative is obtained by reacting activated carbon with a metal salt, including but not limited to a salt comprising a transition metal ion, including but not limited to Fe²⁺, Fe³⁺, Cu²⁺, Zn²⁺, Ni²⁺, Co³⁺.

The term “N-nitroso”, as used herein, alone or in combination, refers to a functional group having the general formula —N—N═O.

The term “N-nitroso compound scavenging”, as used herein, alone or in combination, refers to a process whereby an N-nitroso compound, including but not limited to nitrosamine, is removed from a volume of solid, liquid, or gas. In some embodiments, the scavenging process includes a step of chemical modification, thereby removing the N-nitroso molecule from the molecule. In some embodiments, the chemical modification is chosen from a reduction, an oxidation, a lysis (including hydrolysis), and a condensation. In some embodiments, the scavenging process includes a step of sorption, including but not limited to adsorption to a surface and absorption into a volume, thereby reducing the amount of free N-nitroso compound in the solid, liquid, or gas.

The activated carbon or its derivative, e.g. tris-activated carbon, functions to absorb or adsorb N-nitroso compounds and/or nitrosating agent, e.g. nitrites and/or nitrous acid, due to the high surface area within the structure of the activated carbon. Further chemical treatment can enhance the absorption or adsorption properties of the activated carbon or its derivative.

Without wishing to be bound by a mechanism of action, the scavenging material functions to remove, reduce, scavenge, control or modify the level of the N-nitroso compounds and/or nitrosating agent, e.g., nitrites and/or nitrous acid, in an environment.

Optionally, the scavenging material adorbs or absorbs humidity. In further embodiments, the scavenging material is a desiccant.

The activated carbon or its derivative, e.g. tris-activated carbon, may be provided in any form such as: powder, crushed, granular, particulate, pelletized, spherical, or cylindrical form.

Optionally, the scavenging material is provided in one or more scavenging articles. Optionally, each of the one or more scavenging articles is integral with, affixed to or chemically bonded with the interior of the container. Optionally, each of the one or more scavenging articles is incorporated into the walls, lid, cap, or cover of the container. Optionally, each of the individual compartments in a partitioned container is provided with at least one scavenging article.

### Exemplary Entrained Polymers

Conventionally, desiccants, oxygen absorbers and other active agents have been used in raw form, e.g., as loose particulates housed in sachets or canisters within packaging, to control the internal environment of the package. For many applications, it is not desired to have such loosely stored active substances. Thus, the present application provides compressed components or active entrained polymers comprising active agents, wherein such polymers can be extruded and/or molded into a variety of desired forms, e.g., container liners, plugs, film sheets, pellets and other such structures.

Optionally, such active entrained polymers may include channeling agents, such as polyethylene glycol (PEG), which form channels between the surface of the entrained polymer and its interior to transmit a selected material (e.g., moisture) to the entrained active agent (e.g., desiccant to absorb the moisture). As explained above, entrained polymers may be two phase formulations (i.e., comprising a base polymer and active agent, without a channeling agent) or three phase formulations (i.e., comprising a base polymer, active agent and channeling agent). Entrained polymers are described, for example, in U.S. Pat. Nos. 5,911,937, 6,080,350, 6,124,006, 6,130,263, 6,194,079, 6,214,255, 6,486,231, 7,005,459, and U.S. Pat. Pub. No. 2016/0039955, each of which is incorporated herein by reference as if fully set forth.

Suitable base polymers for use in the disclosure include thermoplastic polymers, e.g., polyolefins such as polypropylene and polyethylene, polyisoprene, polybutadiene, polybutene, polysiloxane, polycarbonates, polyamides, ethylene-vinyl acetate copolymers, ethylene-methacrylate copolymer, poly(vinyl chloride), polystyrene, polyesters, polyanhydrides, polyacrylianitrile, polysulfones, polyacrylic ester, acrylic, polyurethane and polyacetal, or copolymers or mixtures thereof.

Suitable channeling agents in the disclosure include polyglycol such as polyethylene glycol (PEG), ethylene-vinyl alcohol (EVOH), polyvinyl alcohol (PVOH), glycerin polyamine, polyurethane and polycarboxylic acid including polyacrylic acid or polymethacrylic acid. Alternatively, the channeling agent can be, for example, a water insoluble polymer, such as a polypropylene oxide-monobutyl ether, which is commercially available under the trade name Polyglykol B01/240, produced by CLARIANT. In other embodiments, the channeling agent could be a polypropylene oxide monobutyl ether, which is commercially available under the trade name Polyglykol B01/20, produced by CLARIANT, polypropylene oxide, which is commercially available under the trade name Polyglykol D01/240, produced by CLARIANT, ethylene vinyl acetate, nylon 6, nylon 66, or any combination of the foregoing.

### Medicaments

Certain materials, articles of manufacture, and methods are employed for the storage of medicaments susceptible to contamination by an N-nitroso compound. Optionally, the N-nitroso compound is formed during synthesis or processing of the medicament. Optionally, the N-nitroso compound is formed during storage of the medicament in the absence of any preventative measures.

Optionally, the medicament is provided in a solid, liquid, cream or gel form. Optionally, the medicament is provided in granular or powder form. Optionally, the medicament is provided in the form of pills or tablets. Optionally, the pill or tablet is provided without an exterior coating. Optionally, a multi-dosage supply of the medicament is packaged in the container. Optionally, a single dosage corresponds to a single pill or tablet. Optionally, a single dosage corresponds to a small number of pills or tablets, for example, 2, 3, or 4 pills or tablets. Optionally, the package comprises a plurality of compartments, the headspace of each of which being isolated from other compartments in the package. Optionally, individual dosages are packaged into each of the single compartments in the package. Optionally, the package allows retrieval of the dosage from an individual compartment without disturbing the remaining compartments that still contain individual dosages.

### Entrained Polymer Containing Active Agent

Optionally, the active agent is a component of an entrained polymer, which is at least two phases and comprises the active agent and a base polymer. Optionally, the entrained polymer is at least three phases and comprises the active agent, a base polymer, and a channeling agent. The form of the entrained polymer is not limited. Optionally, such entrained polymer is in the form of a film, a sheet, a liner, or a plug.

In general, it is believed that the higher the active agent concentration in the mixture, the greater the absorption, adsorption or releasing capacity (as the case may be) will be of the final composition. However, too high an active agent concentration could cause the entrained polymer to be more brittle, and the molten mixture of active agent, base polymer material and channeling agent to be more difficult to either thermally form, extrude or injection mold.

In one embodiment, the loading level or concentration of the active agent can range from 20% to 80%, optionally 30% to 70%, optionally 30% to 60%, optionally 30% to 50%, optionally from 35% to 70%, optionally from 35% to 60%, optionally from 35% to 55%, optionally from 35% to 50%, optionally 40% to 70%, optionally from 40% to 60%, optionally from 40% to 50%, optionally from 45% to 60%, optionally from 50% to 60% by weight with respect to the total weight of the entrained polymer.

In one embodiment, the base polymer ranges from 10% to 70%, optionally from 20% to 60%, optionally from 20% to 50%, optionally from 20% to 40%, optionally from 30% to 70%, optionally from 30% to 60%, from 30% to 50%, optionally from 40% to 70%, optionally from 40% to 60%, optionally from 40% to 50% by weight of the total composition.

In one embodiment, the channeling agent ranges from 1% to 20%, optionally 1% to 15%, optionally 1% to 10%, optionally 1% to 5%, optionally from 5% to 20%, optionally 5% to 15%, optionally 5% to 10%, optionally from 10% to 20%, optionally from 10% to 15% by weight with respect to the total weight of the entrained polymer.

In one embodiment, an entrained polymer may be a three phase formulation including 50% by weight of active agent, 38% by weight ethyl vinyl acetate (EVA) as a base polymer and 12% by weight polyethylene glycol (PEG) as a channeling agent.

Entrained polymers according to the disclosed concept include base polymer and an active agent (in this case, activated carbon or a derivative thereof) dispersed in the base polymer. Optionally, the entrained polymer may also include a channeling agent, which is preferably polymeric. The channeling agent may form interconnecting channels through the entrained polymer. At least some of the active agent is contained within these channels, such that the channels communicate between the active agent and the exterior of the entrained polymer via channel openings formed at outer surfaces of the entrained polymer.

The entrained polymer may be formed in various ways. For example, the entrained polymer may be in the form of a plug or puck configured to be deposited in a container. Alternatively, the entrained polymer is in the form of an extruded film or cast film. Alternatively, the entrained polymer is in the form of a blown film, as described herein. Alternatively, the entrained polymer may be in the form of a container insert or integral with the inner wall of a container enclosure, such as a layer of a blow molded bottle. Optionally, a skilled person may utilize the teachings of U.S. Pat. Pub. No. 2021/0245413, which is incorporated by reference herein in its entirety, to make a blow molded bottle that incorporates activated carbon or a derivative thereof as an active agent in an active layer of the bottle.

Interconnecting channels in the entrained polymer, such as those disclosed herein, may help to facilitate transmission of a desired material, such as volatilized nitrosamines, through the entrained polymer and to the activated carbon or derivative thereof dispersed in the base polymer. In other words, the base polymer itself acts as a barrier substance within which an active agent may be entrained. The interconnecting channels formed of the channeling agent provide pathways for the desired material to move through the entrained polymer.

Optionally, the entrained polymer may be in the form of an active sheet or film formed used in combination with a barrier sheet to form a composite. The barrier sheet may be a substrate such as foil and/or a polymer with low moisture or oxygen permeability. The barrier sheet is compatible with the entrained polymer structure and is thus configured to thermally bond to the active sheet or film, when the active sheet or film solidifies after extrusion or casting. Optionally, the entrained polymer is an extruded film that is heat staked to a substrate, such as is disclosed in U.S. Pat. No. 8,142,603, which is incorporated by reference herein in its entirety.

Optionally, the active sheet or film and the barrier sheet are combined to form a packaging wrap having active characteristics at an interior surface formed by the entrained polymer in the active sheet or film, and vapor resistant characteristics at an exterior surface formed by the barrier sheet. In this embodiment, the active sheet or film occupies a portion of the barrier sheet.

Optionally, multi-layer films are generated by various routes including extrusion, injection molding, vapor deposition, solvent casting, 100% solids cooling, aqueous dispersion, and blown film. The multi-layer films have a morphology comprising of 2-70% activated carbon or a derivative thereof. The rate of reactivity can be controlled through the introduction of various channeling agents and concentrations of the active agent.

Optionally, the entrained polymer is positioned in a container and substantially all of the interior-facing part of the container is composed of the entrained polymer. Optionally, the container is fabricated so that the entrained polymer is located above the level of a product contained in the package, thereby avoiding direct contact between the active agent and the product.

Also provided is an embodiment in which the scavenging material is not in the form of an entrained polymer. Optionally, the scavenging material is provided in a sachet or cannister that is inserted in a package. Optionally, the sachet or cannister contains one or more pores that are sufficiently small to retain the scavenging material within the sachet or cannister. Optionally, the sachet or cannister is included in the package so as to be located above the level of the product contained in the package, thereby avoiding direct contact between the scavenging material (e.g., the sachet or cannister) and the product.

### Blown Films

In one aspect, there is provided herein a blown film material comprising a base polymer and an active agent, and optionally a channeling agent. The active agent includes a scavenging material that includes an activated carbon, such as tris-activated carbon.

Optionally, the base polymer is chosen from a polyolefin, a polyamide, and a polyester. Optionally, the base polymer is chosen from a polyolefin and a polyester. Optionally, the base polymer is chosen from polyethylene, polypropylene, a polyethylene/polypropylene copolymer, and poly(lactic acid).

Optionally, the base polymer has the formula (—CHR—X—)ₙ with —X— chosen from —CH₂—, —COO—, and —CONH—, and R chosen from H and n-C₁₋₁₀ alkyl.

Optionally, the base polymer comprises at least one block copolymer.

Optionally, the base polymer comprises a block copolymer that comprises a block of ester monomers. In some further embodiments, the base polymer comprises a block copolymer that comprises a block of poly(alkylene) terephthalate monomers. In some further embodiments, the alkylene is chosen from ethylene, propylene, and butylene.

Optionally, the base polymer comprises a block copolymer that comprises a block of polyether glycols.

Optionally, the base polymer comprises a block copolymer that contains both a block of ester monomers and a block of polyether glycols. Optionally, the base polymer comprises a HYTREL® block copolymer. Optionally, the base polymer comprises HYTREL® 7246.

Optionally, the base polymer comprises an ethylene/alpha-olefin copolymer. In some further embodiments, the alpha-olefin is chosen from propylene, 1-butene, 1-pentene; 1-pentene with one or more methyl, ethyl, or propyl substituents; 1-hexene; 1-hexene with one or more methyl, ethyl, or propyl substituents; 1-heptene; 1-heptene with one or more methyl, ethyl, or propyl substituents; 1-octene; 1-octene with one or more methyl, ethyl, or propyl substituents; 1-nonene; 1-nonene with one or more methyl, ethyl, or propyl substituents; ethyl, methyl, or dimethyl-substituted 1-decene; 1-dodecene; and styrene. In some further embodiments, the alpha-olefin is chosen from propylene, 1-butene, 1-pentene, 1-hexene, 1-heptene, 1-octene, 1-nonene, 1-decene, and 1-dodecene.

Optionally, the base polymer comprises two block copolymers. In some further embodiments, one of the two block copolymers is an ethylene/alpha-olefin copolymer as disclosed herein. In some further embodiments, the base polymer comprises EXACT™ 3040. In some further embodiments, one of the two block copolymers is a block copolymer that contains both a block of ester monomers and a block of polyether glycols as disclosed herein. In some further embodiments, the base polymer comprises HYTREL® 7246. In some further embodiments, the base polymer comprises both EXACT™ 3040 and HYTREL® 7246. In some further embodiments, the base polymer consists of a mixture of EXACT™ 3040 and HYTREL® 7246.

Optionally, the base polymer comprises both a polyolefin and a polyester. Optionally, the polyolefin ranges from 10% and 40% by weight of the total composition, optionally between 15% and 30%. Optionally, the polyester ranges from 20% and 80% by weight of the total composition, optionally between 25% and 70%, optionally 30% and 60%. Optionally, the polyolefin has formula (—CH₂CHR—)ₙ, and R is chosen from H and n-C₁₋₁₀alkyl. Optionally, the polyester has formula ((—CH₂)ₘCOO—)ₙ, and m is chosen from 1, 2, 3, 4, and 5. Optionally, the polyester has formula (—CHRCOO—)ₙ, and R is chosen from H and n-C₁₋₁₀alkyl.

Also provided is a method of manufacture for a blown film material as disclosed herein, the method comprising the steps of: extruding a suitable precursor material (e.g., molten mix of a polymer and the scavenging material) in a screw extruder with warming; passing the warmed material through a tubular die; expanding and stretching the warmed material with positive pressure; and allowing the expanded and stretched material to cool.

Optionally, the extrusion is performed at a temperature between 140° C. and 190° C., optionally between 145° C. and 175° C., optionally between 150° C. and 170° C., optionally between 150° C. and 165° C. As used herein, the term “between” includes the endpoints of a stated numerical range.

Optionally, the extrusion is performed with a rotation speed of 5 rpm or greater, optionally 10 rpm or greater, optionally 15 rpm or greater, optionally 25 rpm or greater, optionally 35 rpm or greater, optionally 45 rpm or greater, optionally 55 rpm or greater.

Optionally, the extrusion is performed with a rotation speed of 65 rpm or less, optionally 55 rpm or less, optionally 45 rpm or less, optionally 35 rpm or less, optionally 30 rpm or less, optionally 25 rpm or less, optionally 20 rpm or less.

Optionally, the extrusion is performed with a rotation speed of between 10 rpm and 75 rpm, optionally between 15 rpm and 65 rpm, optionally between 15 rpm and 60 rpm, optionally between 20 rpm and 50 rpm.

Optionally, the extrusion is performed with a rotation speed of between 5 rpm and 35 rpm, optionally between 10 rpm and 30 rpm, optionally between 10 rpm and 25 rpm, optionally between 10 rpm and 20 rpm.

Optionally, the tensile strength of the blown film material is significantly greater than that of a comparable cast extruded film material.

Optionally, the dart impact resistance of the blown film material is significantly greater than that of a comparable cast extruded film material.

Optionally, the transparency of the blown film material is significantly greater than that of a comparable cast extruded film material.

Optionally, the haze of the blown film material is significantly greater than that of a comparable cast extruded film material.

Optionally, the brittleness of the blown film material is significantly less than that of a comparable cast extruded film material.

Optionally, the density of the blown film material is significantly greater than that of a comparable cast extruded film material. Optionally, the density of the blown film material is significantly less than that of a comparable cast extruded film material.

Optionally, the tensile strength of the blown film material in the machine and/or direction is significantly greater than that of a comparable cast extruded film material.

Optionally, the elongation of the blown film material in the machine and/or direction is significantly greater than that of a comparable cast extruded film material.

Optionally, the Young's modulus of the blown film material in the machine and/or direction is significantly greater than that of a comparable cast extruded film material.

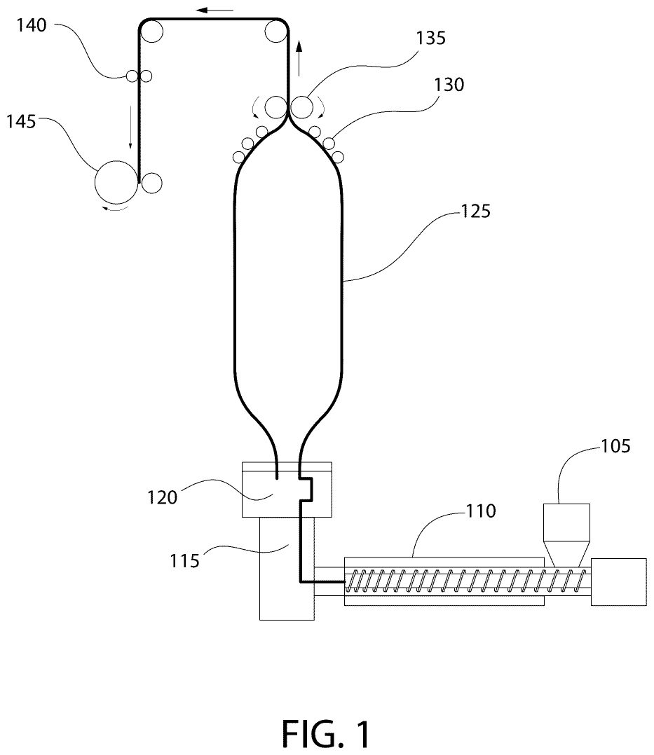

A representative process for forming blown film material is depicted in FIG. 1. A precursor resin, in the form of pellets, is fed into hopper 105 where screw 110 rotates and forces the material forward while heat is applied, gradually forming a melt. The molten material 115 then flows through die 120, resulting in a hollow tube of material. Bubble 125 is formed in the material by introduction of air via a hole in the center of the die. The material progresses upward around the bubble, is cooled, and eventually is allowed to collapse through the action of collapsing frame 130. Throughout this step, nip rolls 135 pull the material upward and maintain proper tension. The collapsed material passes through a series of rollers, including edge trim 140, and is eventually taken up on winder 145.

Due to the nature of the blown film process, certain physical characteristics of the resulting film material may be significantly different than for films manufactured using other techniques, for example cast film extrusion. For example, a cast film process can produce a film with low and/or nonuniform orientation of the polymer strands within the material. In contrast, a blown film material may be highly oriented, with orientation uniform across the cylindrical bubble.

In turn, orientation of the polymer strands within the material can influence the degree of crystallinity, which can affect properties such as clarity/haze, tear strength and elongation, puncture resistance, and toughness.

Mechanical properties in a blown film can be significantly different than those for a cast film. In the blown film process, the material is drawn in both the transverse and machine directions. In contrast, tentered films can have nonuniform strengths in these two directions.

Optionally, in any embodiment, the aforementioned extrusion process includes coextrusion of two or more layers wherein at least one such layer is the active layer (mixture of polymer and active agent) and at least another such layer is a polymer material without an active agent incorporated therein. In such embodiments, what may be formed is a multilayer composite in which at least one layer is an active entrained polymer layer.

### Blister Packages

Blister packages or blister packs according to optional embodiments of the disclosed concept may have structures similar to any one of those described in U.S. Pat. No. 6,279,736 (Hekal), International Publication No. WO 2020/146556 (Hollinger), and International Publication No. WO 2022/236313 (Hollinger), each of which is incorporated herein by reference. Blister packs described in the aforementioned disclosures may include a backing and a cover secured thereto that forms one or more blister cavities. Those blister packs also include an active member, for example, in the form of an active entrained polymer film that is provided within each blister cavity. Such active film in the prior art may have included desiccant, for example, molecular sieve. Blister packs in the prior art and according to the disclosed concept may include a single blister or a plurality of blisters, e.g., greater or fewer than four blisters per blister card.

In an optional aspect of the disclosed concept, the container is a blister pack. Optionally, the blister pack comprises an active agent in the form of activated carbon or a derivative thereof. The active agent is capable to reduce, mitigate or preclude the formation and/or amount of nitrosating agent and/or N-nitroso compound in a headspace within a respective blister cavity and/or in the pharmaceutical dosage form. In addition or as an alternative, the active agent is capable to scavenge an N-nitroso compound from the headspace and/or in the pharmaceutical dosage form.

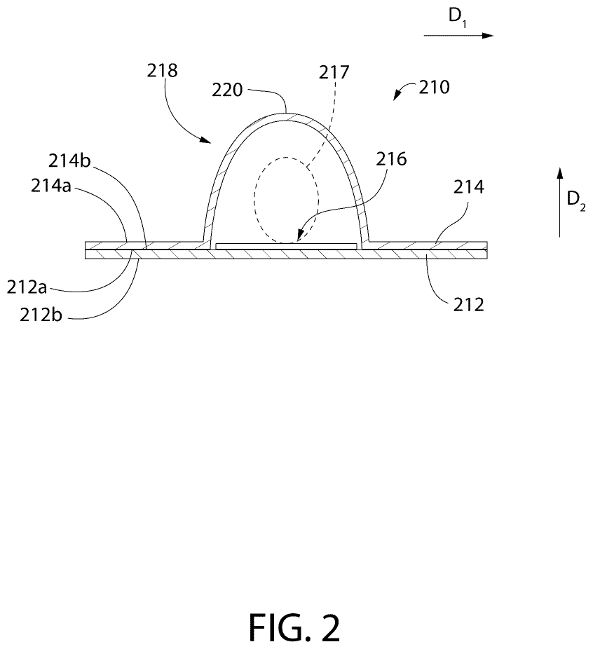

A section view of a single blister of a non-limiting exemplary blister pack 210 (which optionally has a plurality of blisters) is shown in FIG. 2. The blister pack 210 includes a backing 212 and a cover 214 that is attached to the backing 212. Further, the cover 214 is attached to the backing 212 such that at least one cavity or enclosure is formed therebetween or a plurality of spaced-apart cavities/enclosures are formed by the combined cover 214 and backing 212. As a result, the cover 214 and the backing 212 form at least one enclosure that is structured and/or configured to store at least one product 217. Optionally, the cover 214 can have any of a variety of shapes and/or configurations, such as disclosed in WO 2020/146556.

The backing 212 can have a first side or surface 212a and an opposing second side or surface 212b. Optionally, at least the first side 212a of the backing 212 may be flat or planar. In one embodiment, each of the first and second sides 212a, 212b of the backing 212 are flat or planar, such that each of the first and second sides 212a, 212b extends in a plane, which are at least slightly spaced-apart.

The cover 214 can have a first side or surface 214a and an opposing second side or surface 214b. Optionally, at least a portion of the first and second sides 214a, 214b of the cover 214 are flat or planar. At least a portion of the second side 214b of the cover 214 can be attached or adhered, such as by heat staking, thermoforming or cold forming, to the first side 212a of the backing 212 to form a sealed package for containing product(s). The cover 214 can have the same or a different thickness (as measured in the direction of D₂) as the backing 212. In one embodiment, the cover 214 is made or formed of a formable web. In one embodiment, the formable web is made from a thermoplastic material, such as a thermoformed film.

The cover 214 includes or is formed to have at least one blister, generally designated 218. For example, the cover 214 can include two or more spaced-apart blisters 218. The cover 214 can have more or fewer blisters and one or more of the blisters can have a different size and/or shape than another one of the blisters 218 of the blister pack 210, depending upon the particular need. Optionally, each blister 218 can have at least a partial egg shape or a bulbous shape. Alternatively, in one embodiment, each blister 218 can have at least a partial plateau shape (e.g., when viewed from the side) or a cylindrical shape. When the cover 214 is attached to the backing 212, a sealed cavity or enclosure is formed within or by each blister 218.

The blister pack 210 can enclose one or more products 217 (shown schematically in FIG. 2), such as a pharmaceutical oral solid dosage form, vitamins or other nutritional supplements, foodstuff, small consumer goods, probiotics, etc. Such products may be in the form of pills, e.g., tablets, capsules, and the like.

The activated carbon or a derivative thereof is provided in the enclosure formed by each blister 218. For example, the activated carbon or a derivative thereof may be provided as an active agent in an entrained polymer film 216 (e.g., extruded film) deposited within the enclosure. Optionally, the entrained polymer film is adhered to a portion of the inner wall of the enclosure e.g., adhered to the first side 212a of the backing 212. With this configuration, the activated carbon or a derivative thereof is effective to reduce, mitigate or preclude the formation and/or amount of nitrosating agent and/or N-nitroso compound in the at least one enclosure and/or in the pharmaceutical dosage form.

### Inert Atmosphere Packaging

Certain methods disclosed herein provide containers, including blister packages, for packaging of dosage forms, and related methods. In some embodiments, an inert gas is introduced into the container, thereby partially or completely replacing the ambient air within the headspace with the inert gas. The inert gas can be nitrogen or a noble gas such as argon. Introduction of the inert gas can be carried out before, during, or after introduction of the dosage form within the package. It will be understood that partial or complete replacement of ambient air can have the effect of reducing moisture and/or oxygen within the headspace, thereby reducing the potential or degree of hydrolysis or oxidation reactions, respectively. It will further be understood that partial or complete replacement of ambient air during or after introduction of the dosage form, can have the effect of reducing the amount of volatile nitrosamine that was released into the headspace from the dosage form.

### EXAMPLES

The invention is further illustrated by the following examples.

### Example 1: Materials

### Films

Films were manufactured using a single screw extruder to achieve an optimal thickness between 0.3 mm and 1.2 mm. Formulations concerning Tris-Activated Carbon (“T-AC”) and Activated Carbon (“AC”) comprise of 70% resin-3040 and 30% active material. T-AC material is Chemsorb 1505-60 G5 20×50 mesh activated carbon, whereas activated carbon material is Chemsorb 1000-60-G5 activated carbon. The 4A Molecular Sieves (“4A”) and 3A Molecular Sieves (“3A”) were extruded in a formulation comprising of 17% Visparent E100, 3% Activator CC10200143WE, 24% Resin 3040, 3% pvp va64, 30% active, and 24% resin-9074.

### Standard Nitrosamine Solutions

Solutions of NDMA, NDEA, and NDIPA were prepared and calibrated by assaying aliquots of the solutions using GC-MSD analysis, using techniques known in the art.

### Example 2: Nitrosamine Absorption Protocol

The following protocol is employed to examine the absorption of nitrosamine by a potential absorber.

Samples are prepared in duplicate. The potential absorber is added to a 20 mL gas chromatography vial. 50 mg of absorber in raw (non-film) form was used. A solution of a mixed nitrosamine standard in DMSO is then added. The use of DMSO as a diluent for nitrosamines is suggested by the FDA for analysing these compounds at meaningful levels. The samples are then aged for 1 and 3 days at room temperature, along with control solutions. The samples are assayed on a headspace GC-MSD.

### Example 3: Absorption of Nitrosamine by Absorbers

Four samples were analyzed with the protocol of Example 2: (a) 3A molecular sieves (“3A”), (b) 4A molecular sieves (“4A”), (c) activated carbon (“AC”), and (d) Tris-activated carbon (“T-AC”). Results of the assay are provided in Tables 1-3, below. Numbers in the tables reflect percentage of nitrosamine absorbed.

TABLE 1
Absorption of NDMA

| | Absorber | 1 day | 3 days |
|---|---|---|---|
| (a) | 3A | 3% | 3% |
| (b) | 4A | 7% | 7% |
| (c) | AC | 14% | 13% |
| (d) | T-AC | 20% | 21% |

TABLE 2
Absorption of NDEA

| | Absorber | 1 day | 3 days |
|---|---|---|---|
| (a) | 3A | 3% | 4% |
| (b) | 4A | 7% | 6% |
| (c) | AC | 10% | 13% |
| (d) | T-AC | 16% | 16% |

TABLE 3
Absorption of NDIPA

| | Absorber | 1 day | 3 days |
|---|---|---|---|
| (a) | 3A | 35% | −11% |
| (b) | 4A | 8% | 6% |
| (c) | AC | 27% | −25% |
| (d) | T-AC | 21% | −14% |

### Example 4: Protocol for Absorption of Nitrosamine From Impregnated Aspirin

Small “baby” aspirin (81 mg, Bayer) are impregnated with standard nitrosamine solutions in GC tubes. A potential absorber is combined with the material in the GC tube. Samples are aged at 60° C. for 48 h, along with control solutions. The samples are assayed on a headspace GC-MSD. All experiments described in the Examples using small “baby” aspirin employ tablets from the same Bayer lot.

### Example 5: Absorption of Nitrosamine From Impregnated Aspirin by Absorbers

Four samples were analyzed with the protocol of Example 4: (a) 3A molecular sieves (“3A”), (b) 4A molecular sieves (“4A”), (c) activated carbon (“AC”), and (d) Tris-activated carbon (“T-AC”). Results of the assay are provided in Tables 4-6, below.

TABLE 4
Absorption of NDMA from impregnated aspirin

| | Absorber | 48 h |
|---|---|---|
| (a) | 3A | 2.49% |
| (b) | 4A | 4.40% |
| (c) | AC | 8.86% |
| (d) | T-AC | 10.26% |

TABLE 5
Absorption of NDEA from impregnated aspirin

| | Absorber | 48 h |
|---|---|---|
| (a) | 3A | 8.53% |
| (b) | 4A | 12.66% |
| (c) | AC | 14.89% |
| (d) | T-AC | 16.09% |

TABLE 6
Absorption of NDIPA from impregnated aspirin

| | Absorber | 48 h |
|---|---|---|
| (a) | 3A | 8.96% |
| (b) | 4A | 9.83% |
| (c) | AC | 12.23% |
| (d) | T-AC | 15.73% |

### Example 6: Absorption of Nitrosamine From Impregnated Aspirin by Tris-Activated Carbon and 4A

Small “baby” aspirin (81 mg, Bayer) are combined with 4 mL DMSO and 1 mL standard NDMA (0.5 μg/ml) solution is added in GC tubes. 1 cm² of a potential absorber (4A or TAC film) is combined with the material in the GC tube. Samples are aged at 60° C. for 48 h, along with control samples. The samples are assayed on a headspace GC-MSD. Absorbers tested were Tris-Activated Carbon and 4A, in triplicate. Results are shown in Table 7 below.

TABLE 7
Absorption of NDMA from impregnated aspirin

| | | Aspirin | NDMA | Average | |
|---|---|---|---|---|---|
| Sample | | tablets | conc | Conc | % |
| name | Area | (mg) | (ppm) | (ppm) | Reduction |
| Control 1 | 2544 | 222.5 | 1.0057 | 0.9134 | n/a |
| Control 2 | 2194 | 221.7 | 0.8549 | | |
| Control 3 | 2251 | 227.6 | 0.8795 | | |
| T-AC 1 | 2048 | 224.5 | 0.7920 | 0.6775 | 26 |
| T-AC 2 | 1746 | 228.7 | 0.6619 | | |
| T-AC 3 | 1552 | 246.9 | 0.5784 | | |
| 4A 1 | 1673 | 228.0 | 0.6305 | 0.6407 | 30 |
| 4A 2 | 1672 | 226.6 | 0.6301 | | |
| 4A 3 | 1745 | 225.8 | 0.6615 | | |

### Example 7: Absorption of Nitrosamine From Impregnated Aspirin by Absorbers in Blister Packs

Small “baby” aspirin (81 mg, Bayer) were stored in blister packages made with tris-activated carbon film. Tris-Activated Carbon absorbed an average of 7% of NDMA and an average of 35% of NDEA in NDMA-and NDEA-impregnated tablets, respectively, in the modified blister packages (“Sample”) compared to a control lacking the Tris-Activated Carbon film. The samples were assayed on a headspace using GC-MSD.

### Example 8: Lined Bottles

A blow molded bottle completely lined with film containing a potential absorber was used. 4.25 mL of sulfuric acid solution and 4.25 mL of potassium nitrite solution was placed into a 20 mL scintillation vial. The vial was placed inside the blow molded bottle and sealed. GC was conducted on the headspace using the derivative method. The methodology is based on a chemically derivative method that reacts all available nitrites directly into a measurable compound (cyclohexene). The reaction is shown below:

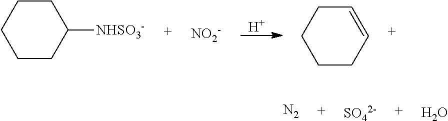

The overall methodology is outlined in “A high-throughput headspace gas chromatographic technique for the determination of nitrite content in water samples”, Shu-Xin Zhang, Rong Peng, Ran Jiang, Xin-Sheng Chai, Donald G. Barnes; Journal of Chromatography A, 1538 (2018) 104-107.

Results of the assay are provided in Table 8.

TABLE 8
Absorption of nitrous acid in lined bottles

| | | | Avg | | | |
|---|---|---|---|---|---|---|
| | Sample | Avg | Concen- | Reduction | Std | |
| Day | Name | Response | tration | (%) | Deviation | Count |
| 1 | Blank | 12926 | 0.02 | | 0.07 | 8 |
| 1 | Control | 4209365 | 58.25 | | 18.30 | 3 |
| 1 | AC | 2571343 | 44.35 | 43.72 | 4.45 | 3 |
| 1 | T-AC | 3779695 | 52.28 | 33.66 | n/a | 1 |
| 2 | Blank | 41451 | 0.31 | | 0.09 | 6 |
| 2 | Control | 3249515 | 44.91 | | 7.62 | 3 |
| 2 | AC | 2156832 | 29.72 | 62.29 | 3.03 | 2 |
| 2 | T-AC | 3633271 | 50.24 | 36.24 | 2.85 | 2 |
| 3 | Blank | 10909 | 0.03 | | 00.10 | 8 |
| 3 | Control | 3669876 | 50.75 | | 7.09 | 3 |
| 3 | AC | 3975363 | 55.00 | 30.20 | 1.54 | 2 |
| 3 | T-AC | 4124518 | 57.07 | 27.57 | 5.70 | 2 |
| 5 | Blank | 106917 | 1.22 | | 0.34 | 7 |
| 5 | Control | 2535418 | 34.98 | | 9.55 | 3 |
| 5 | AC | 2891837 | 39.93 | 49.32 | 7.88 | 3 |
| 5 | T-AC | 2915324 | 40.26 | 48.91 | 6.33 | 2 |
| 6 | Blank | 122667 | 1.44 | | 0.40 | 4 |
| 6 | Control | 2500715 | 34.50 | | 2.18 | 3 |
| 6 | AC | 2686653 | 37.08 | 52.94 | 4.91 | 2 |
| 6 | T-AC | 1679425 | 23.08 | 70.71 | 37.10 | 3 |
| 7 | Blank | 106974 | 1.22 | | 0.56 | 7 |
| 7 | Control | 1278603 | 17.51 | | 5.63 | 3 |
| 7 | AC | 2871172 | 39.65 | 49.68 | 7.09 | 3 |
| 7 | T-AC | 3192330 | 44.11 | 44.02 | 2.26 | 2 |
| 8 | Blank | 26291 | 0.10 | | 0.09 | 7 |
| 8 | Control | 1215797 | 16.63 | | 0.47 | 3 |
| 8 | AC | 2026274 | 27.90 | 64.59 | 12.08 | 3 |
| 8 | T-AC | 60431 | 0.57 | 99.27 | 0.67 | 3 |
| 10 | Blank | 433053 | 5.75 | | 1.68 | 7 |
| 10 | Control | 918821 | 12.51 | | 4.49 | 3 |
| 10 | AC | 490719 | 6.55 | 91.68 | 0.79 | 2 |
| 10 | T-AC | 2018195 | 27.79 | 64.73 | 17.57 | 3 |

Results shown in Table 8 indicate that AC and T-AC lined bottles resulted in a reduction of 91.68% and 64.73%, respectively, in nitrite after 10 days.

### Example 9 Excipient Tablets Without API

Excipient tablets without API were used to test AC. The tablets contain 80% microcrystalline cellulose (MCC), which is a source of nitrite. MCC and lactose are mixed in a 2:1 ratio with small levels of lubricant as required for manufacture.

Three MCC tablets with or without film (2×2 inch) were added to a 2.5×2.5 inch foil bag. Samples were aged at 60° C. for 6 days with or without film. GC was conducted on the headspace using the derivative method. Results of the assay are provided in Table 9 below.

TABLE 9
Absorption of Nitrite Released by Excipient Tablets Without API

| | | Avg | % | PPM | % | |
|---|---|---|---|---|---|---|
| Film Tested | Response | PPM | Reduction | Std Dev | Std Dev | Count |
| Control | 3867357 | 53.5 | | 33.23 | | 10 |
| AC | 659594 | 8.9 | 83.4 | 6.35 | 11.88 | 14 |

Results shown in Table 9 indicate that Activated Carbon film resulted in a reduction of 83.4% in nitrite.

### Example 10: Metformin-Formation of NDMA and/or Nitrite

To determine if film absorbs NDMA, a 1cm² film was submerged in a mixture of 2 mL metformin and 0.1 mL nitrous acid. Samples were aged for 24 hours at room temperature. GC-MSD was conducted on the headspace utilizing unknown analysis for both NDMA and nitrous acid. Results of the assay are provided in Table 10, below.

TABLE 10
NDMA Concentration

| Film Tested | NDMA Concentration (ppm) | % Reduction |
|---|---|---|
| Control | 0.027 | |
| 4A | 0.023 | 14.8 |
| T-AC | 0.019 | 29.6 |

Results shown in Table 10 indicate that Tris-Activated Carbon film resulted in a reduction of 29.6% in NDMA concentration.

To investigate the effect of reducing the amount of nitrous acid used on NDMA concentration, samples prepared as described above but with varying amounts of nitrous acid as shown in Table 11 below.

TABLE 11
NDMA Concentration with Varying
Amounts of Nitrous Acid Used

| Film Tested | Nitrous Acid | | NDMA Concentration (ppm) |
|---|---|---|---|
| T-AC | 0 | mL | 0.000 ppm |
| T-AC | 0.1 | mL | 0.018 ppm |
| T-AC | 0.05 | mL | 0.018 ppm |

Results shown in Table 11 indicate that lowering the amount of nitrous acid from 0.1 mL to 0.05 mL did not result in a reduction of NDMA formed. This indicates that testing may be done using 0.05 mL of nitrous acid.

To investigate the effect of the film on nitrous acid concentration, the same conditions were used as for Table 10. Results are provided in Table 12.

TABLE 12
Nitrite Concentration

| Film Tested | Nitrite Concentration (ppm) | % Reduction |
|---|---|---|
| Control | 0.76 | |
| 4A | 0.52 | 31.6 |
| T-AC | 0.15 | 80.3 |

Results shown in Table 12 indicate that Tris-Activated Carbon film resulted in a reduction of 80.3% in nitrite concentration.

To investigate the effect of reducing the amount of nitrous acid used on nitrite concentration, samples prepared as described above but with varying amounts of nitrous acid as shown in Table 13 below.

TABLE 13
Nitrite Concentration with Varying Amounts of Nitrous Acid Used

| Film Tested | Nitrous Acid | | Nitrite Concentration (ppm) | |
|---|---|---|---|---|
| T-AC | 0 | mL | 0.000 | ppm |
| T-AC | 0.1 | mL | 0.08 | ppm |
| T-AC | 0.05 | mL | 0.05 | ppm |

Results shown in Table 13 indicate that lowering the amount of nitrous acid from 0.1 mL to 0.05 mL still yielded nitrite. This indicates that testing may be done using 0.05 mL of nitrous acid.

### Exemplary Embodiments

The following exemplary embodiments further describe optional aspects of the presently disclosed technology and are part of this Detailed Description. These exemplary embodiments are set forth in a format substantially akin to claims (each with numerical designations followed by a capital letter), although they are not technically claims of the present application. The following exemplary embodiments refer to each other in dependent relationships as “embodiments” instead of “claims.”

### Blown Film

1A. A blown film entrained polymer comprising:
a base polymer; and
activated carbon or a derivative thereof dispersed within the base polymer, optionally wherein the activated carbon or derivative thereof is in a granular, particulate or powdered form.
2A. The blown film entrained polymer as recited in embodiment 1A, wherein the base polymer is chosen from a polyolefin and a polyester.
3A. The blown film entrained polymer as recited in embodiment 2A, wherein the base polymer is a polyolefin having formula (—CH₂CHR—)ₙ, wherein R is chosen from H and C₁₋₁₀alkyl.
4A. The blown film entrained polymer as recited in embodiment 2A, wherein the base polymer is a polyester.
5A. The blown film entrained polymer as recited in embodiment 4A, wherein the polyester has formula (OOC—Y—COO—Z)ₙ, wherein:
Y is 1,4-phenylene, and
Z is chosen from ethylene, butylene, hexylene, and 1,4-cyclohexenedimethylene.
6A. The blown film entrained polymer as recited in embodiment 4A, wherein polyester has formula ((CH₂)ₘCOO)ₙ, wherein m is chosen from 1, 2, 3, 4, and 5.
7A. The blown film entrained polymer as recited in embodiment 4A, wherein the polyester has formula (—CHRCOO—)ₙ, wherein R is chosen from H and C₁₋₁₀alkyl.
8A. The blown film entrained polymer as recited in either one of embodiments 3A and 7A, wherein R is chosen from H, CH₃, (CH₂)CH₃, (CH₂)₃CH₃, (CH₂)₅CH₃, and (CH₂)₇CH₃.
9A. The blown film entrained polymer as recited in embodiment 3A, wherein R is chosen from C₂H₅, C₄H₉, and C₆H₁₃.
10A. The blown film entrained polymer as recited in embodiment 7A, wherein R is CH₃.
11A. The blown film entrained polymer as recited in any one of embodiments 1A-7A, wherein the polymer composition is a monolithic material.
12A. The blown film entrained polymer as recited in any one of embodiments 1A-9A, wherein the base polymer ranges from 10% to 80%, optionally from 20% to 70%, optionally from 30% to 60%, optionally from 40% to 50%, optionally from 45% to 65%, optionally from 45% to 60%, optionally from 45% to 55%, optionally from 50% to 70%, optionally from 50% to 60%, optionally from 55% to 65%, optionally from 55% to 60% by weight of the entrained polymer material.
13A. The blown film entrained polymer as recited in any one of embodiments 1A-3A, 8A and 10A-12A, wherein the base polymer is chosen from polyethylene, polypropylene, and a polyethylene/polypropylene copolymer.
14A. The blown film entrained polymer as recited in embodiment 1A, wherein the base polymer is a block copolymer.
15A. The blown film entrained polymer as recited in embodiment 14A, wherein the block copolymer comprises polyester segments and polyether segments.
16A. The blown film entrained polymer as recited in embodiment 14A, wherein the polyester segment is poly(alkylene terephthalate).
17A. The blown film entrained polymer as recited in embodiment 16A, wherein the polyester segment is poly(butylene terephthalate).
18A. The blown film entrained polymer as recited in any one of embodiments 14A-17A, wherein the polyether segment is a poly(alkylene glycol).
19A. The blown film entrained polymer as recited in embodiment 18A, wherein the polyether segment is chosen from polyethylene glycol, polypropylene glycol, and polytetramethylene glycol.
20A. The blown film entrained polymer as recited in embodiment 14A, wherein the block copolymer is HYTREL®, optionally HYTREL® 7246.
21A. The blown film entrained polymer as recited in any one of embodiments 1A-20A, wherein the activated carbon or derivative thereof comprises 1% to 70%, optionally 10% to 80%, optionally, optionally 20% to 70%, optionally 35% to 65%, optionally from 40% to 60%, optionally from 45% to 55% by weight with respect to the total weight of the material.
22A. The blown film entrained polymer as recited in any one of embodiments 1A-21A, wherein the derivative of activated carbon is tris-modified activated carbon.
23A. The blown film entrained polymer as recited in any one of embodiments 1A-22A, further comprising a channeling agent, optionally wherein the channeling agent is present in a range of 1% to 25%, optionally from 2% to 15%, optionally from 2% to 6%, optionally from 3% to 12%, optionally from 5% to 20%, optionally from 8% to 15%, optionally from 10% to 20%, optionally from 10% to 15%, or optionally from 10% to 12% by weight with respect to total weight of the blown film entrained polymer.
24A. The blown film entrained polymer as recited in embodiment 23A, wherein the channeling agent is chosen from a polyglycol, glycerin polyamine, polyurethane, and polycarboxylic acid, or any combination of the foregoing.
25A. The blown film entrained polymer as recited in embodiment 23A, wherein the channeling agent is chosen from propylene oxide polymerisate, propylene oxide polymerisate-monobutyl ether, ethylene vinyl acetate (EVA), nylon, or any combination of the foregoing.
26A. The blown film entrained polymer as recited in embodiment 23A, wherein the channeling agent is polyethylene glycol (PEG).
27A. A method for manufacturing the blown film entrained polymer as recited in any one of embodiments 1A-26A, comprising the steps of:
extruding suitable precursor material that is a molten mix of the base polymer and the activated carbon or derivative thereof in a screw extruder with warming to form a warmed extruded material;
passing the warmed extruded material through a die;
expanding and stretching the warmed extruded material with positive gas pressure to form an expanded and stretched material; and
allowing the expanded and stretched material to cool, thus forming the blown film entrained polymer.
28A. The method as recited in embodiment 27A, wherein extrusion is performed with a rotation speed of between 5 rpm and 35 rpm, optionally between 10 rpm and 30 rpm, optionally between 10 rpm and 25 rpm, optionally between 10 rpm and 20 rpm.
29A. The method as recited in either one of embodiments 27A or 28A, wherein extrusion is performed at a temperature between 140° C. and 180° C., optionally between 145° C. and 175° C., optionally between 150° C. and 170° C., optionally between 150° C. and 165° C.
30A. The method as recited in any one of embodiments 27A-29A, wherein the method includes coextrusion of at least two layers for forming the expanded and stretched material.
31A. The method as recited in embodiment 30A, wherein a first layer includes the blown film entrained polymer and a second layer includes a polymer material without an active agent, such as activated carbon or a derivative thereof, dispersed therein.
32A. A container comprising the blown film entrained polymer as recited in any one of embodiments 1A-26A or made according to the methods as recited in any one of embodiments 27A-31A and an interior space suitable for storage of a pharmaceutical product.
33A. The container of embodiment 32A, wherein the container is one of a vial, a bottle, a pouch and a blister package.
34A. The container of embodiment 32A or 33A, wherein the blown film entrained polymer is integral with or affixed to an internal wall of the container.
35A. A method for reducing contamination in a pharmaceutical product by formaldehyde, the method comprising storing the pharmaceutical product in the container as recited in any one of embodiments 32A-34A and allowing the blown film entrained polymer to scavenge or otherwise mitigate the formaldehyde.
36A. A method for reducing contamination in a pharmaceutical product by N-nitroso compounds, e.g. nitrosamines, the method comprising storing the pharmaceutical product in the container as recited in any one of embodiments 32A-34A and allowing the blown film entrained polymer to scavenge, inhibit formation of, or otherwise mitigate the N-nitroso compounds, e.g. nitrosamines.

### Methods and Systems for Controlling/Inhibiting N-Nitroso Compounds

1B. A method of reducing, mitigating or precluding formation of and/or amount of nitrosating agent and/or an N-nitroso compound in a pharmaceutical drug package, comprising:
providing an enclosure;
positioning at least one pharmaceutical dosage form in the enclosure;
forming a headspace in the enclosure not occupied by the at least one pharmaceutical dosage form; and
   positioning activated carbon and/or a derivative thereof within the headspace, wherein the activated carbon and/or a derivative thereof is effective to reduce, mitigate or preclude the formation and/or amount of nitrosating agent and/or N-nitroso compound in the headspace and/or in the pharmaceutical dosage form.
2B. The method of embodiment 1B, wherein one or more of the headspace and the at least one pharmaceutical dosage form includes a nitrosating agent and/or an N-nitroso compound.
1C. A system for mitigating the presence of nitrosamine impurities from a drug product and a potential adverse effect on a patient associated therewith, the system comprising:
a package comprising an enclosure and one or more pharmaceutical dosage forms housed within the enclosure, each of the one or more pharmaceutical dosage forms having in it, on it, or having a propensity to form or emit, a nitrosating agent and/or N-nitroso compound that is a source for the potential adverse effect, wherein a headspace is formed within a volume of the enclosure that is not occupied by the one or more pharmaceutical dosage forms, the headspace having disposed therein an effective amount of activated carbon or a derivative thereof to inhibit formation of and/or reduce the presence of the nitrosating agent and/or N-nitroso compound in or on the one or more pharmaceutical dosage forms and/or in the headspace to improve patient safety by reducing the potential adverse effect associated with the drug product through the nitrosating agent and/or N-nitroso compound mitigation provided by the effective amount of activated carbon and/or a derivative thereof.
1D. A method for reducing, mitigating or precluding formation of and/or amount of a nitrosamine in a pharmaceutical dosage form, the method comprising:
providing an enclosure;
positioning the pharmaceutical dosage form in the enclosure;
forming a headspace in the enclosure not occupied by the pharmaceutical dosage form, and
positioning activated carbon and/or a derivative thereof within the headspace,
wherein the activated carbon and/or a derivative thereof is effective to reduce the amount of the nitrosamine in the pharmaceutical dosage form.
2D. The method of embodiment 1D, wherein the nitrosamine has a formula weight of 300 g/mol or less, optionally 200 g/mol or less, optionally 160 g/mol or less, optionally 120 g/mol or less.
3D. The method of embodiment 1D or 2D, wherein the nitrosamine has a vapor pressure at 20° C. of 0.2 Torr or higher, optionally 0.5 Torr or higher, optionally 1 Torr or higher, optionally 2 Torr or higher, optionally 3 torr or higher, optionally 4 torr or higher, or optionally 5 Torr or higher.
4D. The method of any one of embodiments 1D-3D, wherein the nitrosamine has a boiling point at atmospheric pressure of 250° C. or lower, optionally 225° C. or lower, optionally 200° C. or lower, optionally 190° C. or lower, optionally 180° C. or lower, optionally 170° C. or lower, or optionally 160° C. or lower.
5D. The method of any one of embodiments 1D-4D, wherein the nitrosamine is not 1-methyl-4-nitrosopiperazine, 1-cyclopentyl-4-nitrosopiperazine, or N-nitroso-3-azabicyclo[3.3.0]octane.
6D. The method of any one of embodiments 1D-5D, wherein the pharmaceutical dosage form does not comprise any one of rifampicin, rifapentine, or gliclazide.
7D. The method of any one of embodiments 1D-6D, wherein the pharmaceutical dosage form does not comprise either a hydrazone or a semicarbazide moiety.
8D. The method of any one of embodiments 1D-7D, wherein the pharmaceutical dosage does not comprise a functional group that can undergo hydrolysis to provide a primary hydrazine.
9D. The method of any one of embodiments 1D-8D, wherein the nitrosamine is selected from the group consisting of NDMA, NDEA and NDIPA.

### Blister Pack/Drug Delivery System

1E. A drug delivery system, comprising:
a blister pack configured to house multiple pharmaceutical dosage forms, the blister pack comprising:
   a backing;
   a cover attached to the backing, the cover and backing in combination forming at least one enclosure configured to contain a single pharmaceutical dosage form;
a single pharmaceutical dosage form housed within the at least one enclosure;
a headspace formed within a volume of the at least one enclosure that is not occupied by the single pharmaceutical dosage form; and
an active agent comprising activated carbon or a derivative thereof positioned in the at least one enclosure,
wherein the active agent is effective to reduce, mitigate or preclude the formation and/or amount of nitrosating agent and/or N-nitroso compound in the headspace and/or in the pharmaceutical dosage form.
1F. A drug delivery system for mitigating a potential adverse effect associated with the drug, the system comprising:
a package comprising an enclosure and one or more pharmaceutical dosage forms housed within the enclosure, wherein a headspace is formed within a volume of the enclosure that is not occupied by the one or more pharmaceutical dosage forms; and a material that is capable of reducing the rate of formation or inhibiting formation of a nitrosating agent and/or an N-nitroso compound in a headspace within the package and/or in the pharmaceutical dosage form,
wherein the material is separate and apart from the pharmaceutical dosage form stored within the blister pack.
1G. A drug delivery system for mitigating a potential adverse effect associated with the drug, the system comprising:
(e) a blister pack configured to house one or more pharmaceutical dosage forms, the blister pack comprising:
   (iii) a backing;
   (iv) a cover attached to the backing, the cover and backing in combination forming at least one enclosure configured to contain a single pharmaceutical dosage form;
(f) a single pharmaceutical dosage form housed within at least one enclosure;
(g) a headspace formed within a volume of the enclosure that is not occupied by the one or more pharmaceutical dosage forms; and
(h) a material that is capable of reducing the rate of formation or inhibiting formation of a nitrosating agent and/or an N-nitroso compound in a headspace within the package and/or in the pharmaceutical dosage form,
wherein the material is separate and apart from a pharmaceutical dosage form stored within the blister pack.

### Package

1H. A package, comprising:
an enclosure;
at least one pharmaceutical dosage form located within the enclosure;
a headspace within the enclosure not occupied by the at least one pharmaceutical dosage form;
a nitrosating agent and/or an N-nitroso compound located in one or more of the headspace and the at least one pharmaceutical dosage form; and
activated carbon and/or a derivative thereof located within the headspace, wherein the activated carbon is effective to reduce, mitigate or preclude formation and/or amount of nitrosating agent and/or N-nitroso compound in the enclosure and/or the at least one pharmaceutical dosage form.

### Methods of Treatment

1I. A method for treating a patient having a medical condition with a pharmaceutical dosage form that comprises or can form a nitrosating agent and/or a N-nitroso compound, the method being configured to mitigate a potential adverse effect on a patient associated with the nitrosating agent and/or N-nitroso compound, the method comprising:
(e) providing a package comprising an enclosure and one or more pharmaceutical dosage forms housed within the enclosure, wherein a headspace is formed within a volume of the enclosure that is not occupied by the one or more pharmaceutical dosage forms;
(f) providing an amount of activated carbon and/or a derivative thereof in the headspace that is effective in reducing the rate of formation or inhibiting formation of a nitrosating agent and/or an N-nitroso compound in a headspace and/or in the pharmaceutical dosage form within the package, the amount of activated carbon and/or derivative thereof being separate and apart from the one or more pharmaceutical dosage forms;
(g) opening the enclosure to dispense the one or more pharmaceutical dosage forms; and
(h) administering the one or more pharmaceutical dosage forms to provide a therapeutically effective amount of drug to the patient for treating the medical condition with improved patient safety by reducing the potential adverse effect associated with the pharmaceutical dosage form through mitigation of the nitrosating agent and/or N-nitroso compound by the amount of activated carbon or derivative thereof.

### Pharmaceutical Dosage Form

1J. A pharmaceutical dosage form having a propensity to form or emit a nitrosating agent and/or N-nitroso compound that is a source for a potential adverse effect to a patient to whom the pharmaceutical dosage form is administered, the pharmaceutical dosage form being substantially free of an N-nitroso compound through inhibition of formation thereof and/or scavenging thereof by an effective amount of activated carbon and/or a derivative thereof provided in a headspace of a package enclosure when the pharmaceutical dosage form is housed within the enclosure, the effective amount of activated carbon and/or derivative thereof being separate and apart from the pharmaceutical dosage form.
2J. The pharmaceutical dosage form of embodiment 1J, wherein the pharmaceutical dosage form is substantially free of the N-nitroso compound such that the pharmaceutical dosage form includes less than 100%, optionally less than 90%, optionally less than 80%, optionally less than 70% of the FDA or EMA permitted N-nitroso compound content in effect as of 1 Jan. 2024.
3J. The pharmaceutical dosage form of embodiment 1J or 2J, wherein the pharmaceutical dosage form is substantially free of the N-nitroso compound such that the pharmaceutical dosage form includes less than 1500 ppm, optionally less than 400 ppm, optionally less than 100 ppm, optionally less than 95 ppm, optionally less than 90 ppm, optionally less than 85 ppm, optionally less than 80 ppm, optionally less than 75 ppm, optionally less than 70 ppm, optionally less than 65 ppm, optionally less than 60 ppm, optionally less than 55 ppm, optionally less than 50 ppm, optionally less than 45 ppm, optionally less than 40 ppm, optionally less than 35 ppm, optionally less than 25 ppm, optionally less than 20 ppm, optionally less than 15 ppm, optionally less than 14 ppm, optionally less than 13 ppm, optionally less than 12 ppm, optionally less than 11 ppm, optionally less than 10 ppm, optionally less than 9 ppm, optionally less than 8 ppm, optionally less than 7 ppm, optionally less than 6 ppm, optionally less than 5 ppm, optionally less than 4 ppm, optionally less than 3 ppm, optionally less than 2 ppm, optionally less than 1 ppm, optionally less than 0.9 ppm, optionally less than 0.8 ppm, optionally less than 0.7 ppm, optionally less than 0.6 ppm, optionally less than 0.5 ppm, optionally less than 0.4 ppm, optionally less than 0.3 ppm, optionally less than 0.2 ppm, optionally less than 0.1 ppm of total N-nitroso compound.

### Dependent Embodiments

1K. Any one of embodiments 1B-3J, wherein the enclosure comprises an inner wall and the activated carbon or derivative thereof is integral with or affixed to the inner wall.
2K. Any one of embodiments 1B-1K, wherein the pharmaceutical dosage form is an oral dosage form selected from the group consisting of tablet, sublingual tablet, chewable tablet, capsule and liquid-filled capsule.
3K. Any one of embodiments 1B-2K, wherein the N-nitroso compound is a nitrosable compound selected from primary amine, secondary amine, tertiary amine and quaternary ammonium salts.
4K. Any one of embodiments 1B-3K, wherein the N-nitroso compound is a nitrosable compound selected from primary amine, secondary amine, tertiary amine and quaternary ammonium salts.
5K. Any one of embodiments 1B-4K, wherein the N-nitroso compound is a reaction of product of a nitrosable compound and nitrite or a nitrosating agent.
6K. Embodiment 5K, wherein the nitrosating agent is nitrous acid.
7K. Embodiment 5K, wherein the nitrite is sodium nitrite.
8K. Any one of embodiments 1B-7K, wherein the N-nitroso compound is selected from the group consisting of N-nitrosodimethylamine, N-nitrosodiethylamine, R¹R²N—N═O, and a volatile low molecular weight nitrosamine
9K. Any one of embodiments 1B-8K, wherein the nitrosamine is selected from the group consisting of NDMA, NDEA and NDIPA.
10K. Any one of embodiments 1C, 1F, 1G, 11, 1J or 1K-9K, wherein the potential adverse effect is carcinogenicity.
11K. Any one of embodiments 1B-10K, wherein the activated carbon derivative is tris-activated carbon.
12K. Any one of embodiments 1B-11K, wherein the activated carbon and or derivative thereof is provided in a sachet or cannister.
13K. Any one of embodiments 1B-11K, wherein the activated carbon and/or derivative thereof is combined with a binder and compressed into a component that is optionally affixed to or chemically bonded to an interior wall of the enclosure.
14K. Any one of embodiments 1B-11K, wherein the package is a bottle or a vial and the activated carbon and/or derivative thereof is provided in a component affixed to, chemically bonded with (optionally through multi-shot injection molding) or dispersed within a cap of the package and/or an interior wall of the package.
15K. Any one of embodiments 1B-11K, wherein the activated carbon and/or derivative thereof is provided in granular, particulate or powdered form and is dispersed within a base polymer to form an entrained polymer, the entrained polymer optionally further comprising a channeling agent (optionally a polymer channeling agent) that forms channels within the entrained polymer.
16K. Embodiment 15K, the entrained polymer comprising the channeling agent, the channeling agent being present in a range of from 1% to 25%, optionally from 2% to 15%, optionally from 2% to 6%, optionally from 3% to 12%, optionally from 5% to 20%, optionally from 8% to 15%, optionally from 10% to 20%, optionally from 10% to 15%, or optionally from 10% to 12% by weight with respect to total weight of the blown film entrained polymer.
17K. Embodiment 16K, wherein the channeling agent is selected from one or more of the group consisting of: polyglycol, polyethylene glycol (PEG), ethylene-vinyl alcohol (EVOH), polyvinyl alcohol (PVOH), glycerin polyamine, polyurethane, polycarboxylic acid, a propylene oxide polymerisate-monobutyl ether, a propylene oxide polymerisate monobutyl ether, propylene oxide polymerisate, ethylene vinyl acetate, nylon 6, nylon 66, and vinylpyrrolidone-vinyl acetate copolymer 60/40 (PVPVA 64).
18K. Any one of embodiments 15K-17K, wherein the activated carbon and/or derivative thereof is present in 10% to 80%, optionally 20% to 70%, optionally 30% to 70%, optionally 30% to 60%, optionally 30% to 50%, optionally from 35% to 70%, optionally from 35% to 60%, optionally from 35% to 55%, optionally from 35% to 50%, optionally 40% to 70%, optionally from 40% to 60%, optionally from 40% to 50%, optionally from 45% to 60%, optionally from 50% to 60% by weight with respect to the total weight of the entrained polymer.
19K. Any one of embodiments 15K-18K, wherein the base polymer ranges from 10% to 70%, optionally from 20% to 60%, optionally from 20% to 50%, optionally from 20% to 40%, optionally from 30% to 70%, optionally from 30% to 60%, from 30% to 50%, optionally from 40% to 70%, optionally from 40% to 60%, optionally from 40% to 50% by weight of the total weight of the entrained polymer.
20K. Embodiment 15K, wherein the activated carbon and/or derivative thereof is provided in the blown film entrained polymer of any one of embodiments 1A-26A, or made according to the method of any one of embodiments 27A-31A.
21K. Embodiment 20K, the blown film entrained polymer having a thickness of from 0.01 to 0.25 mm, optionally from 0.01 to 0.15 mm, optionally from 0.01 to 0.12 mm, optionally from 0.01 to 1.0 mm, optionally from 0.02 to 0.8 mm, optionally from 0.05 to 0.5 mm, optionally from 0.1 to 0.5 mm.
22K. Any one of embodiments 15K-19K, wherein the entrained polymer is provided as an extruded film or cast film.
23K. Embodiment 22K, the film having a thickness of from 0.1 to 1.2 mm, optionally 0.2 to 1.0 mm, optionally 0.2 to 0.6 mm.
24K. Any one of embodiments 1B-23K, wherein the pharmaceutical dosage form comprises an active pharmaceutical ingredient or a pharmaceutically acceptable salt thereof selected from the group consisting of: Metformin, Ranitidine, Amitriptyline, Nortriptyline, Betahistine, Chloropyramine, Citalopram, Sumatriptan, Lamisil, Terbisil, Zostavax, Tripelennamine, Desvenlafaxine, Orphenadrine, Terbinafine, Ethylisopropylamine, Sitagliptin, Losartan, Valsartan, Atomoxetine, Lidocaine, Azelastine, Duloxetine, Fluoxetine, Chloropyramine, Phenylephrine, Rasagiline, Reboxetine, Aripiprazole, Mitapivat, Rifampicin, Alogliptin, Ranolazine, Rotigotine, Azacyclonol, Quetiapine, Cinacalcet, Desloratadine, Nintedanib, Sildenafil, Landiolol, Mirabegron, Mirtazapine, Valaciclovir, Pramipexole, Ranolazine, Ribociclib, Tetracaine, Trimetazidine, Varenicline, Vortioxetine, Methylphenidate, Paroxetine, Piperidine, Moxifloxacin, Daridorexant, Rotigotine, Ropivacaine, Ambroxol, Atenolol, Benazepril, Betaxolol, Bisoprolol, Bumetanide, Bupropion, Celiprolol, Cilazapril, Ciprofloxacin, Dabigatran Etexilate, Trimebutine, Diclofenac, Dorzolamide, Enalapril, Esmolol, Isosorbide mononitrate, Imatinib, Isosorbide mononitrate, Indapamide, Ketamine, Labetalol, Leniolisib, Levofloxacin, Lisinopril, Metoprolol, Moxifloxacin, Nebivolol, Perindopril, Arpraziquantel, Propranolol, Pseudoephedrine, Quetiapine, Ramipril, Rivaroxaban, Salbutamol, Sertraline, Sotalol, Tamsulosin, Ticagrelor, Urapidil, Vildagliptin, Gliclazide, Mefenamic acid, Azithromycin, Calcium folinate, Calcium levofolinate, Azithromycin, Hydrochlorothiazide and Quinapril.

All references, patents or applications, U.S. or foreign, cited in the application are hereby incorporated by reference as if written herein in their entireties. Where any inconsistencies arise, material literally disclosed herein controls.

From the foregoing description, one skilled in the art can easily ascertain the essential characteristics of this invention, and without departing from the spirit and scope thereof, can make various changes and modifications of the invention to adapt it to various usages and conditions.

1.-24. (canceled)

25. A method of reducing the amount of a nitrosating agent in a pharmaceutical drug package, comprising:
providing an enclosure;
positioning at least one pharmaceutical dosage form in the enclosure;
forming a headspace in the enclosure not occupied by the at least one pharmaceutical dosage form; and
positioning activated carbon and/or a derivative thereof within the headspace, wherein:
the at least one pharmaceutical dosage form has a propensity to form a nitrosating agent;
the activated carbon and/or a derivative thereof is provided in granular, particulate or powdered form and is dispersed within a base polymer to form an entrained polymer; and
the entrained polymer is effective to reduce the amount of nitrosating agent in the headspace and/or in the pharmaceutical dosage form.

26. The method of claim 25, wherein the nitrosating agent is chosen from a nitrite and nitrous acid.

27. The method of claim 25, wherein the entrained polymer is effective to reduce the amount of nitrosating agent in the headspace.

28. The method of claim 25, wherein the derivative of activated carbon is tris-activated carbon.

29. The method of claim 25, wherein the entrained polymer comprises a channeling agent that forms channels within the entrained polymer.

30. The method of claim 25, wherein the activated carbon and/or derivative thereof is present in 20% to 70% by weight with respect to the total weight of the entrained polymer.

31. The method of claim 25, wherein the base polymer ranges from 40% to 70% by weight with respect to the total weight of the entrained polymer.

32. The method of claim 25, wherein the entrained polymer is provided as an extruded film having a thickness of from 0.1 to 1.2 mm.

33. The method of claim 25, wherein the pharmaceutical dosage form comprises an active pharmaceutical ingredient or a pharmaceutically acceptable salt thereof selected from the group consisting of: Metformin, Ranitidine, Amitriptyline, Nortriptyline, Betahistine, Chloropyramine, Citalopram, Sumatriptan, Lamisil, Terbisil, Zostavax, Tripelennamine, Desvenlafaxine, Orphenadrine, Terbinafine, Ethylisopropylamine, Sitagliptin, Losartan, Valsartan, Atomoxetine, Lidocaine, Azelastine, Duloxetine, Fluoxetine, Chloropyramine, Phenylephrine, Rasagiline, Reboxetine, Aripiprazole, Mitapivat, Rifampicin, Alogliptin, Ranolazine, Rotigotine, Azacyclonol, Quetiapine, Cinacalcet, Desloratadine, Nintedanib, Sildenafil, Landiolol, Mirabegron, Mirtazapine, Valaciclovir, Pramipexole, Ranolazine, Ribociclib, Tetracaine, Trimetazidine, Varenicline, Vortioxetine, Methylphenidate, Paroxetine, Piperidine, Moxifloxacin, Daridorexant, Rotigotine, Ropivacaine, Ambroxol, Atenolol, Benazepril, Betaxolol, Bisoprolol, Bumetanide, Bupropion, Celiprolol, Cilazapril, Ciprofloxacin, Dabigatran Etexilate, Trimebutine, Diclofenac, Dorzolamide, Enalapril, Esmolol, Isosorbide mononitrate, Imatinib, Isosorbide mononitrate, Indapamide, Ketamine, Labetalol, Leniolisib, Levofloxacin, Lisinopril, Metoprolol, Moxifloxacin, Nebivolol, Perindopril, Arpraziquantel, Propranolol, Pseudoephedrine, Quetiapine, Ramipril, Rivaroxaban, Salbutamol, Sertraline, Sotalol, Tamsulosin, Ticagrelor, Urapidil, Vildagliptin, Gliclazide, Mefenamic acid, Azithromycin, Calcium folinate, Calcium levofolinate, Azithromycin, Hydrochlorothiazide and Quinapril.

34. A method of reducing the amount, or precluding the formation of, an N-nitroso compound in a pharmaceutical drug package, comprising:
providing an enclosure;
positioning at least one pharmaceutical dosage form in the enclosure;
forming a headspace in the enclosure not occupied by the at least one pharmaceutical dosage form; and
positioning activated carbon and/or a derivative thereof within the headspace, wherein:
the at least one pharmaceutical dosage form has a propensity to form an N-nitroso compound;
the activated carbon and/or a derivative thereof is provided in granular, particulate or powdered form and is dispersed within a base polymer to form an entrained polymer; and
the entrained polymer is effective to reduce the amount of, or preclude the formation of, the N-nitroso compound in the headspace and/or in the pharmaceutical dosage form.

35. The method of claim 34, wherein the N-nitroso compound is chosen from N-nitrosodimethylamine (NDMA), N-nitrosodiethylamine (NDEA), N-nitrosodi-1-propylamine (NDPA), N-nitrosodi-2-propylamine (NDIPA), N-nitrosodi-1-butylamine (NDBA), N-nitroso-N-ethyl-2-propylamine (NEIPA), N-nitroso-N-methylpiperazine (NMP), N-nitroso-N-cyclopentylpiperazine (CPNP), and N-nitrosopyrrolidine (NPYR).

36. The method of claim 35, wherein the N-nitroso compound is chosen from NDMA, NDEA and NDIPA.

37. The method of claim 34, wherein the entrained polymer is effective to reduce the amount of the N-nitroso compound in the headspace.

38. The method of claim 34, wherein the derivative of activated carbon is tris-activated carbon.

39. The method of claim 34, wherein the entrained polymer comprises a channeling agent that forms channels within the entrained polymer.

40. The method of claim 34, wherein the activated carbon and/or derivative thereof is present in 20% to 70% by weight with respect to the total weight of the entrained polymer.

41. The method of claim 34, wherein the base polymer ranges from 40% to 70% by weight with respect to the total weight of the entrained polymer.

42. The method of claim 34, wherein the entrained polymer is provided as an extruded film having a thickness of from 0.1 to 1.2 mm.

43. The method of claim 34, wherein the pharmaceutical dosage form comprises an active pharmaceutical ingredient or a pharmaceutically acceptable salt thereof selected from the group consisting of: Metformin, Ranitidine, Amitriptyline, Nortriptyline, Betahistine, Chloropyramine, Citalopram, Sumatriptan, Lamisil, Terbisil, Zostavax, Tripelennamine, Desvenlafaxine, Orphenadrine, Terbinafine, Ethylisopropylamine, Sitagliptin, Losartan, Valsartan, Atomoxetine, Lidocaine, Azelastine, Duloxetine, Fluoxetine, Chloropyramine, Phenylephrine, Rasagiline, Reboxetine, Aripiprazole, Mitapivat, Rifampicin, Alogliptin, Ranolazine, Rotigotine, Azacyclonol, Quetiapine, Cinacalcet, Desloratadine, Nintedanib, Sildenafil, Landiolol, Mirabegron, Mirtazapine, Valaciclovir, Pramipexole, Ranolazine, Ribociclib, Tetracaine, Trimetazidine, Varenicline, Vortioxetine, Methylphenidate, Paroxetine, Piperidine, Moxifloxacin, Daridorexant, Rotigotine, Ropivacaine, Ambroxol, Atenolol, Benazepril, Betaxolol, Bisoprolol, Bumetanide, Bupropion, Celiprolol, Cilazapril, Ciprofloxacin, Dabigatran Etexilate, Trimebutine, Diclofenac, Dorzolamide, Enalapril, Esmolol, Isosorbide mononitrate, Imatinib, Isosorbide mononitrate, Indapamide, Ketamine, Labetalol, Leniolisib, Levofloxacin, Lisinopril, Metoprolol, Moxifloxacin, Nebivolol, Perindopril, Arpraziquantel, Propranolol, Pseudoephedrine, Quetiapine, Ramipril, Rivaroxaban, Salbutamol, Sertraline, Sotalol, Tamsulosin, Ticagrelor, Urapidil, Vildagliptin, Gliclazide, Mefenamic acid, Azithromycin, Calcium folinate, Calcium levofolinate, Azithromycin, Hydrochlorothiazide and Quinapril.

44. A method for treating a patient having a medical condition with one or more pharmaceutical dosage forms that can form an N-nitroso compound, the method being configured to mitigate a potential adverse effect on a patient associated with the N-nitroso compound, the method comprising:
(a) providing a package comprising an enclosure and one or more pharmaceutical dosage forms housed within the enclosure, the one or more pharmaceutical dosage forms having a propensity to form the N-nitroso compound, wherein a headspace is formed within a volume of the enclosure that is not occupied by the one or more pharmaceutical dosage forms;
(b) providing an amount of entrained polymer in the headspace that is effective in reducing the rate of formation or inhibiting formation of the N-nitroso compound in the headspace and/or in the pharmaceutical dosage form within the package, the entrained polymer comprising activated carbon and/or derivative thereof that is in granular, particulate or powdered form and is dispersed within a base polymer, the entrained polymer being separate and apart from the one or more pharmaceutical dosage forms;
(c) opening the enclosure to dispense the one or more pharmaceutical dosage forms; and
(d) administering the one or more pharmaceutical dosage forms to provide a therapeutically effective amount of drug to the patient for treating the medical condition with improved patient safety by reducing the potential adverse effect associated with the one or more pharmaceutical dosage forms through mitigation of the N-nitroso compound by the amount of entrained polymer.

45. The method of claim 44, wherein the N-nitroso compound is chosen from N-nitrosodimethylamine (NDMA), N-nitrosodiethylamine (NDEA), N-nitrosodi-1-propylamine (NDPA), N-nitrosodi-2-propylamine (NDIPA), N-nitrosodi-1-butylamine (NDBA), N-nitroso-N-ethyl-2-propylamine (NEIPA), N-nitroso-N-methylpiperazine (NMP), N-nitroso-N-cyclopentylpiperazine (CPNP), and N-nitrosopyrrolidine (NPYR).

46. The method of claim 45, wherein the N-nitroso compound is chosen from NDMA, NDEA and NDIPA.

47. The method of claim 44, wherein the amount of entrained polymer is effective to reduce the amount of the N-nitroso compound in the headspace.

48. The method of claim 44, wherein the derivative of activated carbon is tris-activated carbon.

49. The method of claim 44, wherein the entrained polymer comprises a channeling agent that forms channels within the entrained polymer.

50. The method of claim 44, wherein the activated carbon and/or derivative thereof is present in 20% to 70% by weight with respect to the total weight of the entrained polymer.

51. The method of claim 44, wherein the base polymer ranges from 40% to 70% by weight with respect to the total weight of the entrained polymer.

52. The method of claim 44, wherein the entrained polymer is provided as an extruded film having a thickness of from 0.1 to 1.2 mm.

53. The method of claim 44, wherein the pharmaceutical dosage form comprises an active pharmaceutical ingredient or a pharmaceutically acceptable salt thereof selected from the group consisting of: Metformin, Ranitidine, Amitriptyline, Nortriptyline, Betahistine, Chloropyramine, Citalopram, Sumatriptan, Lamisil, Terbisil, Zostavax, Tripelennamine, Desvenlafaxine, Orphenadrine, Terbinafine, Ethylisopropylamine, Sitagliptin, Losartan, Valsartan, Atomoxetine, Lidocaine, Azelastine, Duloxetine, Fluoxetine, Chloropyramine, Phenylephrine, Rasagiline, Reboxetine, Aripiprazole, Mitapivat, Rifampicin, Alogliptin, Ranolazine, Rotigotine, Azacyclonol, Quetiapine, Cinacalcet, Desloratadine, Nintedanib, Sildenafil, Landiolol, Mirabegron, Mirtazapine, Valaciclovir, Pramipexole, Ranolazine, Ribociclib, Tetracaine, Trimetazidine, Varenicline, Vortioxetine, Methylphenidate, Paroxetine, Piperidine, Moxifloxacin, Daridorexant, Rotigotine, Ropivacaine, Ambroxol, Atenolol, Benazepril, Betaxolol, Bisoprolol, Bumetanide, Bupropion, Celiprolol, Cilazapril, Ciprofloxacin, Dabigatran Etexilate, Trimebutine, Diclofenac, Dorzolamide, Enalapril, Esmolol, Isosorbide mononitrate, Imatinib, Isosorbide mononitrate, Indapamide, Ketamine, Labetalol, Leniolisib, Levofloxacin, Lisinopril, Metoprolol, Moxifloxacin, Nebivolol, Perindopril, Arpraziquantel, Propranolol, Pseudoephedrine, Quetiapine, Ramipril, Rivaroxaban, Salbutamol, Sertraline, Sotalol, Tamsulosin, Ticagrelor, Urapidil, Vildagliptin, Gliclazide, Mefenamic acid, Azithromycin, Calcium folinate, Calcium levofolinate, Azithromycin, Hydrochlorothiazide and Quinapril.

54. The method of claim 44, wherein the adverse effect is carcinogenicity.
